(19) United States
(12) Patent Application Publication
(10) Pub. No.: US 2026/0288831 A1
(43) Pub. Date: Sep. 24, 2026

(54) SYSTEM

(71) Applicant: SoftBank Group Corp., Tokyo (JP)

(72) Inventor: Kenta HORIKOSHI, Tokyo (JP)

(73) Assignee: SoftBank Group Corp., Tokyo (JP)

(21) Appl. No.: 19/564,320

(22) Filed: Mar. 12, 2026

(30) Foreign Application Priority Data
Mar. 19, 2025 (JP) 2025-044954

(51) Int. Cl. G06F 16/334; G06F 16/332; G06F 16/34

(52) U.S. Cl. CPC G06F 16/3344; G06F 16/332; G06F 16/345

(57) ABSTRACT

A system includes a processor that is configured to: extract related information from a database and organize the related information by using an analysis algorithm; analyze a comment history of an evaluator by using a natural language processing technique and record tendencies based on the analysis; and generate a prompt sentence for instructing a generative AI model to perform document generation and automatically generate a document by using the generative AI model.

### CROSS-REFERENCE TO RELATED APPLICATION

This application is based on and claims priority under 35 USC 119 from Japanese Patent Application No. 2025-044954 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In conventional document preparation and review workflows, a large amount of time and effort is required for collecting related information from various databases, organizing the collected information into a coherent structure, and drafting documents in a form suitable for evaluation. Furthermore, evaluators repeatedly provide comments on similar types of deficiencies or unclear explanations, and such comment histories are often not systematically analyzed or utilized to improve subsequent document generation. As a result, documents frequently fail to reflect the tendencies and preferences of individual evaluators, causing repeated revisions, elongated review cycles, and reduced overall efficiency. In addition, even when documents are automatically generated by a generative AI model, the generated documents may be lengthy or complex and may not be summarized or presented in a format that is easy for the evaluator to understand, which further hinders the evaluation process. Accordingly, there is a need for a system capable of automatically extracting and organizing related information, learning evaluator-specific comment tendencies through natural language processing, generating documents with a generative AI model based on such tendencies, and further summarizing and presenting the generated documents in an evaluator-friendly format, thereby improving the efficiency and quality of document preparation and review.

### SUMMARY

To solve the above-described problems, a system according to one aspect of the present invention comprises a processor, wherein the processor is configured to extract related information from a database and organize the related information by using an analysis algorithm. The processor is further configured to analyze a comment history of an evaluator by using a natural language processing technique and record tendencies based on the analysis, such as frequently raised issues, preferred levels of detail, and recurring focus points. In addition, the processor is configured to generate a prompt sentence for instructing a generative AI model to perform document generation, the prompt sentence being formulated in accordance with the organized related information and the recorded tendencies of the evaluator, and to automatically generate a document by using the generative AI model in response to the generated prompt sentence. In some embodiments, the processor is further configured to summarize the automatically generated document and present the summarized document in a format that is easy for the evaluator to understand, for example by extracting and condensing key points or restructuring the content. In further embodiments, the processor is configured to present the summarized document to the evaluator in such an evaluator-friendly format so as to promote understanding by the evaluator and thereby shorten review time and reduce the number of required revisions.

The term “system” refers to an aggregation of one or more hardware components and software components that cooperate to execute the processing specified in the claims, including at least one processor and optionally one or more storage devices, communication interfaces, and user interfaces.

The term “processor” refers to one or more hardware processing units, such as a central processing unit (CPU), a graphics processing unit (GPU), a digital signal processor (DSP), or any combination thereof, that executes instructions to perform the functions described in the claims.

The term “database” refers to any structured or semi-structured data storage system, including but not limited to relational databases, key-value stores, document databases, or data warehouses, in which related information, comment histories, and recorded tendencies are stored and from which such data can be retrieved.

The term “related information” refers to information stored in the database that is relevant to the document to be generated or reviewed, including but not limited to project information, past reports, evaluation criteria, and any other data used as a source for document generation. The term “analysis algorithm” refers to one or more algorithms or procedures executed by the processor to organize, classify, filter, or otherwise process the related information extracted from the database so as to prepare the information for use in document generation. The term “comment history” refers to a collection of past comments, annotations, or feedback provided by an evaluator on one or more documents or items under review, the collection being stored in the database and used for subsequent analysis.

The term “evaluator” refers to a person or entity responsible for reviewing a document, providing comments or feedback on the document, or making an assessment or approval decision based on the document.

The term “natural language processing technique” refers to any computational method or model for analyzing, understanding, or processing human language, including but not limited to tokenization, part-of-speech tagging, sentiment analysis, topic extraction, and clustering of textual comments.

The term “tendencies” refers to patterns or characteristics identified from the comment history of an evaluator, including but not limited to frequently raised issues, preferred levels of detail, recurrent topics of interest, and stylistic preferences, which are recorded and used to influence subsequent document generation.

The term “generative AI model” refers to a machine learning model capable of generating natural language text based on input data or instructions, including but not limited to large language models, transformer-based models, or other neural network-based text generation models.

The term “prompt sentence” refers to a text input or instruction generated by the processor for the generative AI model, the text input specifying conditions, constraints, or content requirements for document generation, and being constructed at least in part based on the organized related information and the recorded tendencies of the evaluator.

The term “automatically generate a document” refers to the operation in which the processor causes the generative AI model to output a document in natural language without requiring the evaluator to manually draft the main body of the document, based on the prompt sentence and related information.

The term “summarize” refers to processing performed by the processor to condense the content of the automatically generated document by extracting, selecting, or composing key information so that the resulting summarized document is shorter and easier to understand than the original document.

The term “format that is easy for the evaluator to understand” refers to a presentation format in which the content of the summarized document is organized, structured, or highlighted in a way that facilitates quick grasp of key points by the evaluator, such as by using headings, bullet points, section-wise summaries, or other layout techniques.

The term “promote understanding” refers to enhancing the evaluator's comprehension of the content of the summarized document, for example by reducing the cognitive load required to identify important information, thereby supporting faster and more accurate review or decision-making.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

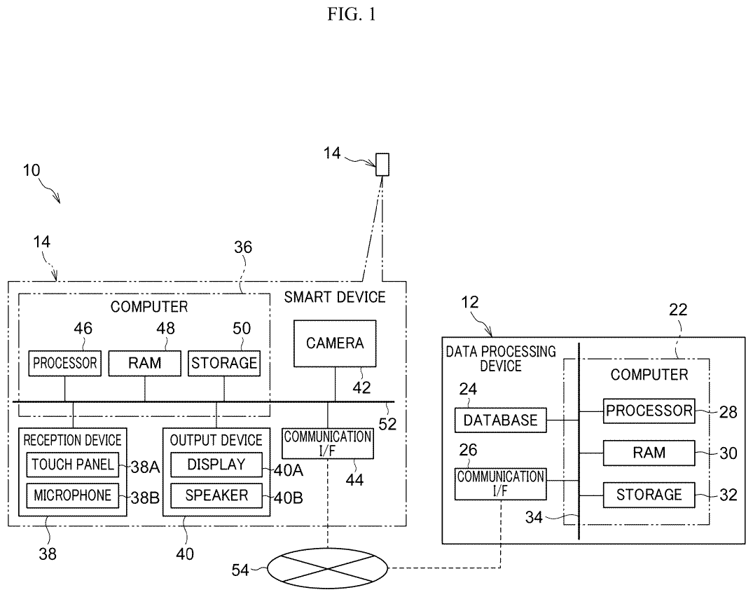

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

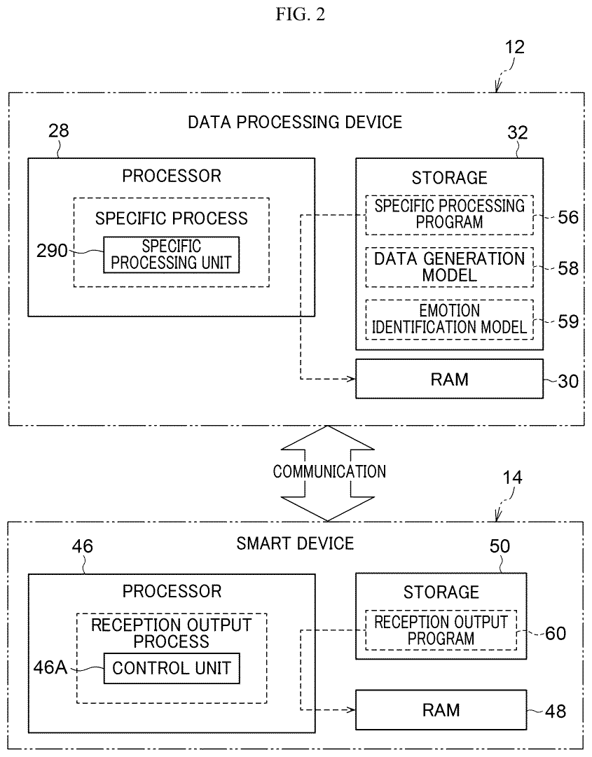

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional approval workflow systems primarily function as electronic document repositories and routing tools. In such systems, report items for each approval stage are manually determined and manually filled by users, and evaluators review static documents without systematic support from machine analysis. As a result, several technical problems arise in the context of computer-implemented approval processing.

First, a conventional system does not effectively utilize historical approval data and evaluator comment history stored in databases. Although large amounts of structured and unstructured data may exist, typical systems only perform simple retrieval or filtering operations. The system therefore fails to compute machine-interpretable indicator values about risk evaluation, budget planning, and personnel allocation, and fails to model evaluator-specific comment tendencies. This leads to technically inefficient use of storage and processing resources because the stored data does not contribute to improved automated behavior of the system. Second, in conventional systems, prompt sentences for generative AI models, if used at all, are usually handcrafted, static, and detached from the actual state of the database and the evaluator's historical behavior. The system does not dynamically construct prompts based on structured analysis results or updated comment tendencies. As a consequence, the generative AI model often produces generic or misaligned documents, requiring extensive manual correction. This results in unnecessary processor cycles for repeated revisions, increased network traffic for repeated document exchanges, and increased latency in the end-to-end approval process.

Third, conventional approval support systems do not provide a feedback loop in which evaluator viewing behavior and comment histories are continuously aggregated and fed back into the document generation process. Without such a closed loop, the system cannot adapt its internal models to highlight information that particular evaluators care about, and cannot improve the precision of its recommendation logic over time. This results in repeated generation of documents that omit information important to the evaluator, causing additional queries, corrections, and re-submissions, and thereby degrading overall computational efficiency of the workflow.

Fourth, traditional systems typically present long, unstructured documents to evaluators, forcing evaluators to spend significant time to identify key risks and critical budget or staffing issues. From a computer-technical perspective, the system does not generate derived artifacts such as automatically structured summaries targeted for rapid comprehension, even though the underlying data and analysis are available. This fails to exploit the processing capability of the system to reduce the time and computing resources needed for evaluators to reach a decision.

Accordingly, there is a need for a computer-implemented approval support system that: (i) systematically analyzes approval-related data and evaluator comments stored in electronic storage; (ii) computes indicator values and evaluator-specific comment tendencies using statistical and natural language processing techniques; (iii) dynamically constructs prompt sentences for a generative AI model based on such computed results; (iv) automatically generates and stores approval documents and summaries for each stage; and (v) closes the loop by feeding evaluator behavior and comments back into the analysis, thereby continuously improving document generation quality and the efficiency of the overall approval process executed by the computer system.

The specific processing by the specific processing unit 290 of the data processing device 12 in Example 1 is realized by the following means.

The present invention provides a server comprising a processor and a storage device, the processor being configured to receive report item data input from a user terminal for each stage of an approval procedure, convert the report item data into structured data, and store the structured data in the storage device as an information set; to extract, from the information set, historical data related to past approval procedures and comment history data of an evaluation entity, and to calculate, by executing analysis processing including statistical processing and natural language processing, indicator values related to risk evaluation, budget planning, and personnel allocation, and comment tendency information for the evaluation entity, and to record the indicator values and the comment tendency information in the storage device; to identify, based on the indicator values and the comment tendency information, report items required in a next stage of the approval procedure, and to generate internal representation data that defines, for each of the report items, description contents to be included and viewpoints to be emphasized; to generate a prompt sentence for instructing a generative AI model to generate a document by combining, in a predetermined language format, explanation information including the internal representation data and the indicator values; to transmit the prompt sentence to the generative AI model via a communication interface, receive document data for the approval procedure output from the generative AI model, and automatically generate and store, in the storage device, a report document to be used in the next stage of the approval procedure based on the document data; to generate feedback information for a user indicating additional information to be provided and items to be corrected in the next stage of the approval procedure based on the automatically generated report document and results of the analysis processing, and to transmit the feedback information to the user terminal; and to accumulate, as the comment history data, approval results and comment information acquired from the evaluation entity, to update the comment tendency information based on the accumulated comment history data, and to dynamically adjust a generation process of the internal representation data so that interest items of the evaluation entity are reflected in subsequent prompt sentences. This enables the server to technically improve the approval workflow by utilizing stored data to automatically compute evaluator-specific analysis metrics, to generate context-adaptive prompt sentences and documents that reduce manual editing, to provide machine-generated feedback and summaries that accelerate evaluator understanding, and to iteratively refine document generation behavior based on evaluator interactions, thereby reducing processing redundancy, communication overhead, and latency within the computer-implemented approval system.

The term “approval procedure” refers to a sequence of computer-implemented processing stages in which electronic information related to a project, service, or matter to be approved is generated, transmitted, analyzed, and evaluated, and in which an evaluation entity renders an approval-related decision based on such information.

The term “user terminal” refers to an information processing device, such as a personal computer, a tablet, or a smartphone, that executes a user interface program and communicates with a server via a communication network to transmit report item data and receive feedback or document data.

The term “evaluation entity” refers to a human or organizational decision-making body that uses a display device or user terminal to review approval-related documents and summaries, to input comments and decisions, and whose evaluation behavior is recorded and analyzed by the system.

The term “processor” refers to a hardware processing unit, such as a central processing unit or other programmable processing circuitry, configured to execute instructions to perform the data reception, analysis, document generation, feedback generation, and storage operations described in the claims.

The term “storage device” refers to an electronic data storage resource, such as a memory device or a database system, configured to store structured data, historical data, comment history data, indicator values, internal representation data, prompt sentences, document data, and feedback information.

The term “information set” refers to an organized collection of electronically stored data records, including structured data representing report items, historical approval data, and comment history data, which is used as a basis for analysis processing by the processor. The term “report item data” refers to electronic data representing approval-related information units, including but not limited to risk evaluation data, budget planning data, and personnel allocation data, that are input by a user for each stage of an approval procedure. The term “historical data” refers to previously stored electronic records related to past executions of approval procedures, including past report items, analysis results, approval results, and associated metadata.

The term “comment history data” refers to electronically recorded textual or symbolic comment information and related metadata that have been input by an evaluation entity during current or past approval procedures and stored for later analysis.

The term “analysis processing” refers to a series of computation operations executed by the processor, including statistical processing and natural language processing, for deriving indicator values and comment tendency information from the information set.

The term “statistical processing” refers to computational operations such as aggregation, averaging, variance calculation, correlation calculation, or other quantitative analysis performed on numerical data related to approval procedures.

The term “natural language processing” refers to computational techniques for machine processing of human-readable language data, including operations such as tokenization, part-of-speech analysis, sentiment analysis, topic analysis, or text classification applied to comment history data or document text.

The term “indicator values” refers to quantitatively expressible metrics computed by the processor, including metrics related to risk evaluation, budget planning, and personnel allocation, which are used to characterize the state or quality of approval-related data. The term “risk evaluation” refers to an analysis domain in which the processor calculates numerical or categorical metrics representing the magnitude, probability, or impact of potential adverse events associated with a project or service.

The term “budget planning” refers to an analysis domain in which the processor handles planned or actual resource allocation data, such as cost items and expense categories, and derives indicator values related to financial aspects of a project or service.

The term “personnel allocation” refers to an analysis domain in which the processor handles data about human resources, such as roles, headcounts, or work allocations, and derives indicator values related to staffing sufficiency and distribution.

The term “comment tendency information” refers to data representing one or more patterns or preferences of an evaluation entity, derived from comment history data and viewing behavior, and indicating which topics, risk types, or data items the evaluation entity tends to focus on. The term “internal representation data” refers to structured data generated by the processor that encodes, for each report item required in a next stage of an approval procedure, description contents to be included and viewpoints to be emphasized, and that serves as an intermediate representation for prompt sentence generation.

The term “prompt sentence” refers to a text sequence generated by the processor in a predetermined language format, including explanation information and indicator values, and configured as an instruction to a generative AI model to cause the generative AI model to generate document data.

The term “generative AI model” refers to a machine-implemented model, such as a parameterized neural network, configured to generate natural language text or other content in response to a prompt sentence and associated input data.

The term “document data” refers to electronically stored data representing natural language content generated by the generative AI model or by summarization processing, including report documents and summaries to be used in an approval procedure.

The term “report document” refers to document data generated or updated by the processor based on output from the generative AI model, and configured to be used as an approval-related document in a particular stage of an approval procedure.

The term “feedback information” refers to electronic information generated by the processor for presentation to a user, indicating additional information to be provided, items to be corrected, or recommended actions for a next stage of an approval procedure.

The term “summarized document data” refers to document data generated by the processor through summarization processing, in which main points related to risk evaluation, budget planning, and personnel allocation are extracted and simplified from a longer report document.

The term “presentation data” refers to data generated by the processor and formatted for output on a display device, including summarized document data, report documents, analysis results, and feedback information.

The term “viewing operations” refers to interaction data acquired from an evaluation entity via a display device or user interface, such as scrolling actions, section selections, or document opening events, which indicate how the evaluation entity accesses and reviews document data.

The term “comment input history” refers to electronically recorded information representing comments or annotations entered by an evaluation entity in association with viewing or reviewing document data, together with temporal or contextual metadata.

The term “communication interface” refers to a hardware and software interface configured to enable data exchange between the server and external devices or services, including user terminals and a generative AI model, via a communication network.

The term “dynamic adjustment” refers to a process in which the processor modifies, over time and in response to updated comment tendency information, one or more parameters or rules used for generating internal representation data and prompt sentences, so that subsequent prompts more closely reflect interest items of an evaluation entity.

In one embodiment, a server cooperates with a terminal and a user to implement the claimed system. The server includes at least one processor, a main memory, a non-volatile storage device, and a communication interface connected to a communication network. The terminal includes a processor, a memory, a display device, and an input device, and executes a browser or a dedicated client application. The user operates the terminal to provide approval-related data and to review documents and feedback generated by the server. The server uses a general-purpose operating system, an application server, and a database management system. The server uses a programming environment such as a Python runtime and an application framework such as a web framework to implement application logic. The server uses a relational database management system such as a SQL-based database to store structured data including report item data, historical data, comment history data, indicator values, internal representation data, prompt sentences, document data, and feedback information. The server uses a generative AI model implemented as a neural network, which can run on the same hardware as the server or on an external inference service accessible via the communication interface.

The terminal uses a browser program to render graphical user interface elements transmitted from the server. The user uses the terminal to input report item data such as risk evaluation data, budget planning data, and personnel allocation data. The server receives the report item data via the communication interface and converts the report item data into structured data objects. The server stores the structured data in tables of the database, each table having a defined schema with fields for project identifiers, approval stages, report item categories, numeric scores, textual descriptions, and timestamps.

The server uses libraries such as a numerical computation library and a table-oriented data processing library to load structured data from the database into in-memory data structures. For example, the server uses a DataFrame structure in which each row represents a record such as a risk entry or a budget entry, and each column represents an attribute such as category, numerical value, or evaluator identifier. The server uses such structures to perform statistical processing. The server calculates descriptive statistics including means, variances, quantiles, and correlation coefficients for risk scores, budget deviations, and personnel allocation metrics across historical data subsets filtered by project type, approval stage, or other conditions.

The server uses a natural language processing pipeline to analyze comment history data. The server stores comment history data in a text field in the database and also stores metadata such as evaluator identifier, project identifier, and approval stage. The server applies tokenization, stop-word removal, and stemming to the textual content. The server constructs feature vectors by counting occurrences of tokens or by computing term frequency-inverse document frequency (TF-IDF) values. The server optionally uses word embeddings or contextual embeddings computed by a language model to represent comment texts as vectors in a continuous feature space.

The server uses these feature representations to derive comment tendency information. The server groups comment vectors by evaluator identifier and applies clustering algorithms or topic modeling algorithms such as latent Dirichlet allocation to identify themes that an evaluation entity frequently addresses. The server determines weights for categories such as security, compliance, performance, cost, schedule, usability, and reliability, based on term frequencies and topic assignments. The server records, in the database, per-evaluator tendency vectors that associate each evaluator identifier with a numerical weight vector over such categories. The server periodically updates these vectors when new comments are stored, thereby adapting comment tendency information over time.

The server defines internal representation data structures for each approval stage and for each report item category. The internal representation data includes fields such as an identifier of the report item, a target evaluator group, a list of required sub-items, and a list of emphasized viewpoints. The server populates these fields by combining static configuration data and dynamic values derived from indicator values and comment tendency information. For example, when a particular evaluator exhibits a strong tendency toward security and compliance topics, the server assigns higher weights to security-related viewpoints in the internal representation data for risk items. The server also encodes constraints such as maximum allowed length, required numerical justifications, and required references to historical averages in the internal representation data.

The server constructs a prompt sentence for the generative AI model by serializing internal representation data and indicator values into a human-readable natural language format. The server uses templates that define sections such as “Context,” “Data Summary,” “Evaluator Preferences,” and “Generation Instructions.” The server inserts concrete numerical values and category names into placeholders of these templates. For instance, the server inserts an overall risk score, variance percentages in budget categories, and staffing sufficiency metrics. The server also inserts descriptions of evaluator tendencies such as “the primary evaluator focuses on security and regulatory compliance.”

The server transmits the prompt sentence to the generative AI model via the communication interface. In one embodiment, the generative AI model is a transformer-based neural network with multiple layers of self-attention and feed-forward sublayers, trained on large corpora of text data using a next-token prediction objective. The generative AI model processes the prompt sentence token by token, encodes the sequence using positional embeddings and attention mechanisms, and generates a probability distribution over candidate next tokens at each decoding step. The server specifies generation parameters such as maximum output length, sampling temperature, and stopping criteria. The server receives the generated tokens from the generative AI model and concatenates them to form document data.

The server does not treat the generative AI model as a black box. The server configures layer counts, hidden dimension sizes, attention head counts, and vocabulary size according to hardware constraints. The server tunes generation parameters to optimize factual consistency with the structured data. The server may fine-tune the generative AI model on domain-specific data sets comprising past approved documents paired with structured indicator values. The server uses a supervised fine-tuning method in which the loss function is cross-entropy between generated token distributions and ground truth tokens, and the server updates neural network weights by gradient descent with backpropagation. The server may perform additional reinforcement learning from human feedback, where evaluator ratings or approval outcomes are used to adjust model behavior.

The server post-processes the generated document data. The server parses headings and paragraphs based on delimiters or markup inserted by the generative AI model. The server checks for the presence of required elements defined in the internal representation data, such as explicit mention of high-risk items and explicit comparison between planned and historical budgets. The server may apply rule-based corrections or fill in missing numerical references using the structured data. The server stores the final report document in the database with a reference to the corresponding project and approval stage. The server also stores a machine-readable representation of the document structure, such as a tree of sections and subsections, which facilitates later summarization and retrieval.

The server generates summarized document data using a separate summarization module. The server uses an extractive or abstractive summarization algorithm to condense the report document. The server may represent the document as a graph of sentences and compute centrality scores, or may use a neural encoder-decoder architecture trained for summarization. The server ensures that main points related to risk evaluation, budget planning, and personnel allocation are included in the summarized document data. The server then generates presentation data for the terminal, which includes the summarized document, the full report document, and selected analysis results such as visual indicators of risk levels and budget variances.

The terminal receives the presentation data and renders it on the display device. The user uses the terminal to read the summarized document and the report document. The user may edit certain sections using a text input interface. The server receives the edits and stores updated document versions in the database. The server maintains version identifiers and timestamps to track changes. The server can compute differences between versions to measure how much manual modification is needed after automatic generation. The server may use such measurements as signals to further refine internal representation data and prompt templates. The server collects viewing operations from the terminal. The terminal sends interaction events such as which sections the user expands, how long the user views each section, and which links the user activates. The server stores these viewing operations as part of the comment history data for the corresponding evaluator or user. The server analyzes these viewing operations using statistical methods. For example, the server detects which document sections repeatedly attract long viewing durations. The server correlates these observations with comment tendency information to refine models of evaluator interests. The server then adjusts future internal representation data and prompt sentences so that sections that evaluators tend to scrutinize are made more detailed or are moved earlier in the document. The server, by performing these steps, improves computational performance and resource usage compared to a simple electronic document workflow. The server reduces redundant database queries by computing and caching indicator values and comment tendency information. The server lowers communication load between the server and the generative AI model by constructing prompt sentences that include only relevant subsets of data rather than transmitting entire raw histories. The server improves accuracy of generated documents by enforcing alignment between structured indicator values and textual explanations in the prompt sentence and by incorporating evaluator-specific tendencies. The server reduces processing time for evaluators by generating summarized document data optimized for quick comprehension and by prioritizing content according to learned preferences.

In one example, the user uses the terminal to initiate an approval procedure for a new online payment service. The user inputs risk evaluation data describing fraud risk, system downtime risk, and regulatory risk, along with probability and impact levels. The user also inputs budget planning data describing development, infrastructure, and marketing expenses, and personnel allocation data describing numbers and roles of engineers and support staff. The server calculates an overall risk score that is higher than the historical mean for similar projects and calculates that the total budget exceeds the historical average by twenty-five percent. The server identifies that a particular evaluator has strong comment tendencies on security and compliance topics. The server then constructs a prompt sentence such as: “You are a generative AI model assisting an internal approval workflow. Based on the analyzed data below (risk scores, budget variances, and personnel allocation) for a new payment service, generate a comprehensive draft report for the ‘Executive Review’ phase. Clearly explain the high-risk items, justify the proposed budget, and comment on whether the staffing plan is sufficient. Address security risks and regulatory compliance in detail.” The server includes, in the prompt sentence, concrete numerical values and short tables summarizing indicator values. The generative AI model produces a report document that contains explicit discussion of fraud detection mechanisms, regulatory requirements, and justification for the increased budget in terms of additional security controls and monitoring infrastructure. The server stores the document and creates summarized document data emphasizing those sections. The evaluator then uses the terminal to review the summary, and the server records viewing operations and comments to update comment tendency information.

The server applies non-conventional combinations of rule-based logic, statistical modeling, and neural generation that differ from simple human emulation. The server enforces consistency between structured numerical data and generated text using rule-based verification and correction. The server uses evaluator-specific tendency vectors to modify prompt content in a way that a human user is unlikely to perform manually for each document, particularly across large numbers of projects and stages. This non-human pattern of combining multiple data sources, internal representation data, and dynamic prompt construction enables the server to reduce errors such as omission of important risk categories and misalignment between budgets and textual justification.

In alternative embodiments, the server may use different database technologies, such as a document-oriented database for storing comment history data, or a graph database for representing relationships between evaluators, projects, and topics. The server may use different generative AI models, such as a smaller transformer model optimized for on-premises deployment or a recurrent neural network-based model for environments with limited hardware resources. The server may implement the natural language processing pipeline using different tokenization schemes, such as byte-pair encoding or unigram language models, and may represent comment texts using different embeddings, such as dynamic contextual embeddings or static word embeddings.

In another embodiment, the server partitions responsibilities across multiple modules. A data ingestion module handles reception and normalization of report item data. An analysis module performs statistical processing and natural language processing on the information set. A profile module maintains evaluator profiles and comment tendency information. A prompt construction module generates internal representation data and prompt sentences. A generation interface module communicates with the generative AI model. A document management module stores, retrieves, and versions report documents and summarized document data. An interaction logging module records viewing operations and comment input history from the terminal. A learning module periodically updates evaluator profiles and adjusts internal representation data generation rules based on new interaction data.

In each embodiment, the server uses the described hardware and software configuration and the specific data structures and algorithms to implement the claimed features. The server thereby provides a concrete technological improvement in the functioning of a computer-implemented approval system, including improved accuracy and usefulness of automatically generated documents, reduced processing time and communication load, and adaptive behavior that continually refines document generation based on evaluator interactions.

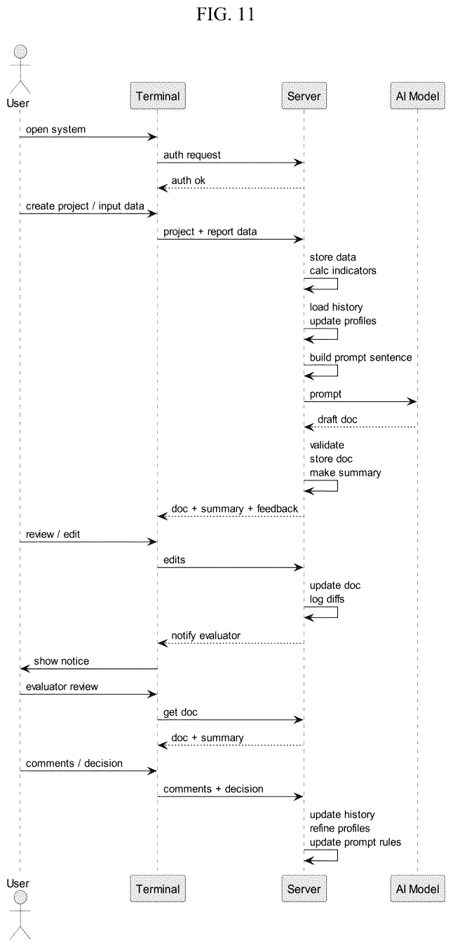

The following describes the processing flow using FIG. 11.

### Step 1:

The user uses the terminal to open a client application or browser and access the server over a network.

The terminal sends an authentication request as input to the server, including user identification data and credential data.

The server receives the authentication data as input, compares hashed credential values with stored credential records in a database, and outputs an authentication result and a session identifier.

The terminal receives the session identifier as output and stores the session identifier in a session storage area for subsequent communication with the server.

### Step 2:

The user uses the terminal to request creation of a new approval procedure and to input basic project metadata such as project name, project type, target launch date, and responsible department.

The terminal sends the project metadata and the session identifier as input to the server. The server receives the project metadata as input, generates a unique project identifier by incrementing a counter or using a UUID generation algorithm, and stores a new project record in a project table in a database.

The server outputs the project identifier and a definition of the first approval stage to the terminal.

The terminal receives the project identifier and stage definition as output and displays an initial approval screen.

### Step 3:

The user uses the terminal to input report item data for the current approval stage, including risk evaluation entries, budget planning entries, and personnel allocation entries.

The terminal validates formats and required fields locally, packages the report item data and the project identifier as input, and sends this input to the server via a secure communication channel.

The server receives the report item data as input, parses the data into structured representations such as records or objects, and outputs structured data objects organized by category (risk, budget, personnel) in memory.

The server stores these structured data objects in corresponding tables in the database (for example, a risk table, a budget table, and a personnel table) and outputs a confirmation signal to the terminal.

### Step 4:

The server uses the project identifier as input to retrieve historical data related to similar projects and stages from the database.

The server filters historical records by project type, approval stage, and report item category, and loads the filtered records into in-memory tabular data structures.

The server performs statistical data processing on these historical records as input, computing output values such as mean risk scores, standard deviations, median budget amounts, and typical personnel counts for each role.

The server stores these statistical summaries as indicator baselines in memory and optionally in a dedicated historical summary table in the database.

### Step 5:

The server uses the newly received structured report item data as input and converts qualitative values into quantitative values.

The server maps textual risk levels (for example, “High,” “Medium,” “Low”) to numeric codes, converts currency strings to normalized numeric currency values, and normalizes date formats to a standard representation.

The server calculates output indicator values for the current project, such as risk scores (probability×impact), total planned budget, budget per major category, total personnel count, and personnel per role.

The server stores these indicator values in an indicator table linked to the project identifier and the current stage identifier.

### Step 6:

The server uses historical comment history data and evaluator identifiers as input and executes a natural language processing pipeline.

The server tokenizes each comment, removes stop words, applies stemming or lemmatization, and computes feature vectors such as term frequency-inverse document frequency vectors or embedding vectors.

The server uses these feature vectors as input to clustering or topic modeling algorithms and computes output comment tendency information for each evaluator, such as category weights for security, compliance, performance, cost, and schedule.

The server stores the comment tendency vectors in a profile table keyed by evaluator identifiers.

### Step 7:

The server uses the current project indicator values and the evaluator profile data as input to determine which report items are required in the next approval stage.

The server queries a configuration table defining, for each stage, mandatory report item categories and conditional requirements based on thresholds.

The server compares the indicator values with threshold conditions (for example, overall risk score higher than a threshold or budget variance greater than a threshold) and uses evaluator tendencies as additional weighting input.

The server outputs an internal representation structure in which each required report item is annotated with description elements, required numerical references, and emphasized viewpoints aligned with evaluator tendencies.

The server stores this internal representation data in an internal representation table associated with the project and next stage.

### Step 8:

The server uses the internal representation data and the indicator values as input to construct a prompt sentence for a generative AI model.

The server selects a template based on the next approval stage and inserts concrete values such as risk scores, budget variances, and staffing sufficiency metrics into the template fields. The server also inserts evaluator preference information, such as “the primary evaluator focuses on security and regulatory compliance,” into a designated portion of the template. The server outputs a composed prompt sentence as plain text, for example: “You are a generative AI model assisting an internal approval workflow. Based on the analyzed data below (risk scores, budget variances, and personnel allocation) for a new payment service, generate a comprehensive draft report for the ‘Executive Review’ phase. Clearly explain the high-risk items, justify the proposed budget, and comment on whether the staffing plan is sufficient. Address security risks and regulatory compliance in detail.”

The server sends the prompt sentence together with metadata such as maximum length and style constraints as input to the generative AI model.

### Step 9:

The generative AI model, running on a server-side inference environment, receives the prompt sentence as input and executes a transformer-based neural network that has been previously trained.

The generative AI model encodes the prompt into hidden representations using multiple attention layers and then decodes an output sequence token by token, computing a probability distribution over a vocabulary at each decoding step.

The server receives generated tokens as output from the generative AI model via the communication interface, assembles the tokens into coherent text segments, and outputs raw document data containing multiple sections such as risk summary, budget justification, and staffing assessment.

The server stores the raw document data in temporary memory for post-processing. Step 10:

The server uses the raw document data and the internal representation data as input to validate and refine the generated text.

The server checks, using rule-based logic, whether all required report items are mentioned and whether numerical references in the text are consistent with stored indicator values.

The server identifies missing elements or inconsistencies as intermediate output and corrects them by inserting missing sentences or replacing incorrect numbers with correct values derived from the indicator table.

The server outputs a validated report document and stores the validated report document in a report table in the database linked to the project and stage.

### Step 11:

The server uses the validated report document as input for summarization processing. The server segments the document into sentences, computes importance scores for each sentence using statistical or neural summarization methods, and selects a subset of sentences that collectively cover main points of risk evaluation, budget planning, and personnel allocation.

The server generates summarized document data as output, preserving logical order and adding brief section headings for clarity.

The server stores the summarized document data in a summary table and prepares presentation data that includes both the full report document and the summarized document.

### Step 12:

The server uses the validated report document, the summarized document data, the indicator values, and the comment tendency information as input to generate feedback information for the user.

The server identifies, from the indicator values, any missing supporting data or unusual values and from the internal representation data any still-unaddressed viewpoints.

The server compiles these findings into feedback text, indicating which additional information should be provided or which sections may require clarification or correction.

The server outputs feedback information and presentation data and sends these outputs to the terminal through the communication interface.

### Step 13:

The terminal receives the presentation data and the feedback information as input and renders them on the display device.

The terminal displays the summarized document in a summary pane, displays the full report document in a scrollable detail pane, and displays feedback messages in a separate notice area.

The user uses the terminal to review the documents and feedback, and optionally edits sections of the report document using text editing controls.

The terminal packages user edits as input and sends the edited text and associated identifiers back to the server.

### Step 14:

The server receives user edits as input and merges the edited sections into the existing report document stored in the database.

The server assigns a new version identifier to the edited document, records a timestamp, and computes text diffs between the original and edited content to measure the extent of modifications.

The server stores the updated document and the diff metrics as output, which are later used to evaluate the performance of prompt construction and generative text quality.

The server may use these diff metrics as additional features in a learning process that adjusts internal representation generation rules.

### Step 15:

The server uses evaluator identifiers and project identifiers as input to determine which evaluation entity should receive the generated documents for the current stage.

The server retrieves contact information and notification preferences from an evaluator profile table and composes notification messages including links or access tokens to the stored report and summary.

The server outputs notification messages and transmits them via an email server or messaging system to the corresponding terminals of evaluators.

The evaluators then use their terminals to access the server and load the report documents for review.

### Step 16:

The terminal of each evaluator receives a request from the evaluator to view the documents and sends a document retrieval request as input to the server.

The server receives the retrieval request, verifies access rights, and loads the corresponding report document and summarized document data from the database.

The server outputs these documents to the evaluator's terminal as formatted presentation data. The terminal displays the documents and records viewing operations such as section expansions, scroll depths, and dwell times as interaction data.

### Step 17:

The evaluator uses the terminal to input comments and approval or rejection decisions in association with the displayed report document.

The terminal sends the comments, decisions, and interaction data (viewing operations) as input to the server.

The server receives this input and stores comment texts in the comment history table, stores decisions in a decision table, and stores interaction data as part of evaluator behavior logs. The server outputs updated comment history data and updated approval status for the project. Step 18:

The server uses newly stored comment history data and interaction data as input for periodic profile updates.

The server re-runs the natural language processing pipeline on newly added comments, updates feature vectors, recalculates topic distributions or category weights, and merges these updates with existing comment tendency vectors for each evaluator.

The server also analyzes interaction data to weight tendencies based on which sections are frequently inspected.

The server outputs refined comment tendency information and stores the updated vectors back into the evaluator profile table.

### Step 19:

The server uses the refined comment tendency information and the performance metrics of previous document generations as input to adjust rules and parameters used for internal representation data generation and prompt construction.

The server modifies weightings for certain topics in the internal representation data, updates thresholds for including or omitting details, and adjusts template text fragments used in prompt sentences.

The server outputs updated configuration parameters and templates and stores them in configuration tables or configuration files.

The server thereby ensures that subsequent prompt sentences and generated documents are more closely aligned with evaluator interests and reduce the need for manual edits and clarifications.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional workflow management systems and document generation tools in approval procedures, such as those used for introducing new production lines or other complex operational changes, largely behave as static form engines and generic document repositories. These systems typically retrieve predefined fields from a database and present them to evaluators without dynamically adapting the content or presentation to the specific approval stage, the accumulated evaluation history, or the individual tendencies of evaluators. As a result, computer resources are not used efficiently to prioritize and structure information in a way that reduces cognitive load on evaluators, and the speed and reliability of decision making remain limited.

In existing systems, processors usually execute fixed templates and simple rule-based formatting when preparing documents. Such processing does not exploit advanced natural language processing or generative models to reorganize heterogeneous data into a structured, evaluator-aware explanation. Consequently, evaluators are often required to manually search, cross-check, and interpret distributed datasets, leading to redundant data access operations on storage devices, repeated manual edits of documents, and increased latency in completing an approval stage. These behaviors degrade overall computer system throughput and increase the number of interactions between user terminals and servers, thereby causing inefficiencies in network usage and database access patterns.

Moreover, known systems generally treat evaluator comments and feedback as unstructured text logs that are merely stored, rather than as a source of machine-readable evaluator profiles. Without automatically analyzing comment histories by natural language processing, processors are unable to derive numerical tendency information that captures which items or risk factors a particular evaluator tends to emphasize. This lack of structured evaluator profiles prevents the processor from tailoring generated documents and user interface content, causing both over-inclusion of low-relevance details and omission of high-priority information. In turn, this increases the number of revision cycles and repetitive document generation operations, which further burdens computing resources.

Additionally, conventional approval management platforms seldom integrate generative AI models in a way that systematically uses structured stage information, reporting information, and evaluator tendency information to construct optimized prompt sentences. When generative models are used at all, they are typically invoked with ad hoc prompts written manually by users. Such manual prompt creation is not scalable and results in inconsistent quality, as well as unnecessary computational load due to poorly constrained input. For example, large unfiltered datasets may be sent to a generative model, causing excessive token usage, longer processing times, and increased cost, without corresponding improvement in relevance or clarity of the generated output.

Furthermore, existing systems do not efficiently manage iterative revision cycles in a machine-centric manner. When an evaluator issues a revision instruction, systems often lack mechanisms to automatically reconfigure the prompt to a generative model based on the specific revision content and to selectively acquire additional reporting information. Instead, users manually edit documents or perform additional data retrieval, which multiplies interactions with the storage device and network. This manual loop not only delays the approval process but also prevents the processor from optimizing internal workflows such as caching, incremental data updates, and version management of generated documents. Another problem with conventional technology is that the reuse of past approval cases is under-automated. While some systems allow searching historical records by keywords or identifiers, they do not use generative models to compute integrated summary information across multiple past cases, such as common points and differences in risk patterns or decision rationales. Without such integrated summaries generated directly in the server, users must read multiple long documents individually, increasing the number of display operations at terminals and the volume of data transferred from the server. This hampers the ability of the overall computer system to support rapid and informed decision making based on historical knowledge.

Accordingly, there is a need for an improved computer-implemented system in which a processor automatically (i) associates approval stages with required reporting information, (ii) analyzes evaluator comment histories by natural language processing to obtain numerical tendency information, (iii) constructs and regenerates prompt sentences for a generative AI model using structured reporting information and tendency information, (iv) controls automatic generation and revision of explanatory documents, and (v) generates stage-aware and evaluator-aware summaries and integrated historical insights. Such a system should improve the efficiency of data retrieval, document generation, and user interaction, thereby enhancing the overall performance and technical effect of the computer system in managing complex approval procedures.

The specific processing by the specific processing unit 290 of the data processing device 12 in Application Example 1 is realized by the following means.

The present invention provides a server comprising a processor and a storage device, the processor being configured to associate each stage in an approval procedure with reporting information required in the stage, acquire the reporting information from the storage device based on stage information identifying the stage, and format the acquired reporting information as structured information; acquire evaluation history data of an evaluator from the storage device, analyze the evaluation history data by using a natural language processing technique, and convert a degree of interest and a priority item of the evaluator into numerical tendency information to be recorded in the storage device; generate a prompt sentence for a generative information processing model based on the structured reporting information and the tendency information, input the prompt sentence and the structured reporting information into the generative information processing model to cause the generative information processing model to automatically generate an explanatory document, and store the explanatory document in the storage device; record progress status of the approval procedure as status information in the storage device, transmit the explanatory document and the status information to a user terminal via a communication network, receive response information including an approval instruction or a revision instruction from the user terminal, and update the status information based on the response information; and, when the revision instruction is received, regenerate the prompt sentence based on the revision instruction and additionally acquired reporting information, input the regenerated prompt sentence into the generative information processing model, and cause the generative information processing model to automatically generate a revised explanatory document. This enables the computer system to automatically tailor explanatory documents and summary presentations to approval stages and evaluator tendencies, reduce redundant data retrieval and manual document editing, optimize use of generative AI model resources through structured prompt generation and regeneration, and improve overall processing efficiency and responsiveness of approval procedures executed by the server and the user terminals.

The term “system” refers to an information processing arrangement including at least one processor and at least one storage device, optionally connected to one or more user terminals via a communication network.

The term “processor” refers to a hardware computation unit, such as a central processing unit or a programmable processing circuit, that executes instructions to perform data acquisition, analysis, generation, and control operations described in the claims.

The term “storage device” refers to a non-transitory computer-readable medium, such as a magnetic disk, semiconductor memory, or optical storage, that stores data, programs, explanatory documents, profiles, and status information used by the processor. The term “approval procedure” refers to a multi-stage workflow in which one or more evaluators or approvers review information and issue approval instructions or revision instructions for a target object such as a project, product, or process.

The term “stage in an approval procedure” refers to a defined phase or step within the approval procedure that has associated required reporting information, responsible roles, and status transitions.

The term “stage information” refers to data that identifies or describes a particular stage in the approval procedure, including at least a stage identifier and optionally attributes such as stage type, order, and required reporting items.

The term “reporting information” refers to structured or semi-structured data that is required to be presented or considered at a particular stage in the approval procedure, such as risk information, cost information, schedule information, or performance information.

The term “structured information” refers to data that has been organized into a defined format, such as a table, record set, or key-value structure, enabling programmatic processing, aggregation, and formatting by the processor.

The term “evaluator” refers to a person or entity that reviews reporting information and generated documents during the approval procedure and provides comments, approval instructions, or revision instructions.

The term “evaluation history data” refers to historical records related to evaluations performed by an evaluator, including comment texts, decisions, timestamps, associated stages, and related metadata.

The term “natural language processing technique” refers to a computational method that analyzes and processes human language text, such as tokenization, parsing, sentiment analysis, topic extraction, or classification.

The term “tendency information” refers to numerical or symbolic data representing degrees of interest, priority levels, or focus areas of an evaluator, derived from analysis of the evaluation history data by the natural language processing technique.

The term “generative information processing model” refers to a machine learning model, such as a generative AI model, that is configured to generate natural language text, summaries, or documents in response to input data and instructions.

The term “prompt sentence” refers to a textual instruction, including optional embedded structured data, that is supplied to the generative information processing model to specify a generation task, constraints, or a desired output style.

The term “explanatory document” refers to a text document generated at least in part by the generative information processing model, which explains, summarizes, or analyzes reporting information for use in the approval procedure.

The term “revised explanatory document” refers to an explanatory document that has been newly generated by the generative information processing model in response to a revision instruction and optionally additional reporting information.

The term “status information” refers to data representing a current progress state of the approval procedure or a particular stage, including at least a workflow state and optionally timestamps, responsible roles, and pending actions.

The term “user terminal” refers to an information processing apparatus, such as a personal computer, mobile terminal, or workstation, that is operated by a user and communicates with the server via a communication network to display documents and send instructions. The term “communication network” refers to a wired or wireless data communication infrastructure, such as a local area network or a wide area network, that enables data transfer between the server and the user terminal.

The term “response information” refers to data sent from the user terminal to the server in reaction to presented documents or status information, including at least an approval instruction or a revision instruction and optionally comments or metadata.

The term “approval instruction” refers to response information that indicates that an evaluator or approver accepts a current state or document in the approval procedure.

The term “revision instruction” refers to response information that indicates that an evaluator or approver requests modification, supplementation, or regeneration of an explanatory document or reporting information.

The term “additionally acquired reporting information” refers to reporting information that is obtained by the processor after a revision instruction is received, in order to supplement or refine previous reporting information for use in regenerating a prompt sentence or an explanatory document.

The term “display document” refers to a document derived from an explanatory document, optionally summarized or reformatted, that is prepared by the processor for presentation on a user interface of the user terminal.

The term “integrated summary information” refers to a synthesized summary generated by the generative information processing model based on explanatory documents and status information of multiple past cases, including at least common points and differences among the cases.

The term “past case” refers to an approval instance that has been previously processed in the approval procedure, for which explanatory documents and status information are stored in the storage device.

In one embodiment, a server includes a processor, a main memory, a non-transitory storage device, and a network interface. The server executes an operating system such as a general-purpose server operating system and application software implemented, for example, in a high-level language such as Python. The server cooperates with at least one terminal operated by a user. The terminal includes a display unit, an input device, a local processor, and a network interface, and executes a web browser or dedicated client application. The server stores, in the storage device, a database that includes at least: a stage information table that associates stages in an approval procedure with required reporting information; a collected data table that stores structured reporting information; a reviewer profile table that stores tendency information of evaluators; a generated document table that stores explanatory documents generated by a generative AI model; and a workflow status table that stores status information of approval cases. The server may implement the database using a relational database management system such as a general-purpose relational engine. The server accesses these tables through database drivers.

The server represents each stage in the approval procedure by a stage identifier, a stage type, a stage order index, and a set of mandatory item identifiers. Each mandatory item identifier corresponds to a reporting information definition that describes a data type (for example, numeric, categorical, text), a source system identifier (for example, production management system, cost management system), and an aggregation function (for example, sum, average, maximum, minimum). The server stores these definitions in the storage device as table rows or configuration records.

The server represents reporting information in a structured format. For numerical reporting information, the server uses a schema including a key attribute such as a product line identifier, equipment identifier, or time period, and one or more value attributes such as a risk score, cost amount, or capacity utilization. For textual reporting information, the server uses a schema including a text field and metadata fields such as language code and category. The server uses a data processing library, such as a numerical analysis library and a tabular data library, to load query results into in-memory data frames, to perform type conversion, and to apply aggregation functions.

The server acquires evaluation history data of an evaluator from the database. The evaluation history data includes at least comment text, decision type, associated stage identifier, and timestamp. The server applies a natural language processing pipeline to each comment text. In one embodiment, the server uses a tokenization module to split the text into tokens, a part-of-speech tagging module to assign grammatical categories, and a lemmatization module to normalize word forms. The server may employ an open-source natural language processing library running on the same processor or in a cooperating process.

The server computes tendency information for each evaluator by extracting features from the processed comments. The server may use a term-weighting technique such as term-frequency-inverse-document-frequency to derive feature vectors representing the frequency and importance of domain-specific terms (for example, “safety incident,” “defect rate,” “budget overrun”). The server may then apply a classifier, such as a logistic regression model or a feedforward neural network, trained on labeled evaluation history data to map feature vectors to scores along multiple dimensions (for example, safety focus, quality focus, cost focus, schedule focus). The server stores the resulting scores as numerical tendency information in the reviewer profile table, along with representative keywords extracted by a keyword extraction algorithm.

In one embodiment, the server uses a generative AI model as the generative information processing model. The server may access a transformer-based neural network model having multiple self-attention layers, feedforward sublayers, and layer normalization modules. The model parameters include token embedding vectors, positional encodings, attention weight matrices, and feedforward layer weights. The model may be pretrained on a large corpus of text and optionally fine-tuned on domain-specific documents such as risk reports and approval summaries. The server interacts with the model via an application programming interface exposed by a model serving system. The server transmits tokenized prompt sentences and structured data representations to the model and receives token sequences representing generated text.

In one embodiment, the server constructs the prompt sentence by concatenating an instruction segment, a context segment describing the approval stage, and a data segment including structured reporting information. The server may convert structured data, such as tables stored in the data frames, into a textual representation that preserves row and column semantics. For example, the server may generate a textual table header followed by row lines. The server also incorporates tendency information into the prompt sentence by inserting phrases that instruct the generative AI model to emphasize certain dimensions.

For example, the server may generate a prompt sentence of the following form: “Generate an approval summary for this new product line introduction. Emphasize quality and safety because the main reviewer historically focuses on defect rates and safety incidents. Use the following structured data and provide a concise, executive-level explanation. Data: [risk assessment table], [budget breakdown table], [production capacity forecast].”

In another example, when a revision instruction is received, the server may generate a prompt sentence of the following form:

“Revise the existing risk and budget explanation for this product line introduction. The approver requested more detail on fire-prevention systems and long-term maintenance costs. Expand those sections while keeping the overall structure similar. Original text: [previous explanatory document text]. Additional data: [fire-prevention metrics], [maintenance cost schedule].”

In still another example related to reuse of past cases, the server may generate a prompt sentence of the following form:

“Summarize key lessons learned from these past product line introductions that are similar to the current case. Focus on risk patterns, budget overruns, and mitigation measures. Input documents: [excerpts from multiple past explanatory documents].”

The server tokenizes each prompt sentence and the associated data using the same subword tokenizer that was used for training the generative AI model, thereby ensuring alignment of token indices with the model's embedding matrix. The server controls generation parameters such as temperature, top-k or top-p sampling thresholds, and maximum output length, and adjusts these parameters based on the type of approval stage to reduce unnecessary generation and save computation.

The server uses an internal module architecture in which a stage management module, a data acquisition module, a natural language processing module, a profile generation module, a prompt generation module, a model interaction module, and a document management module communicate through shared data structures and message queues. The server assigns each approval case an identifier and maintains state transitions in the workflow status table. The server updates status information upon receiving response information from the terminal. The server improves computational efficiency by restricting the data passed to the generative AI model to only those features and items that are relevant to the current stage and evaluator tendencies. The server achieves this by performing an internal filtering process: the server matches stage-specific mandatory items with data availability flags in the collected data table, and the server selects only fields whose importance scores exceed a threshold derived from the tendency information. This reduces the size of the data segment in the prompt sentence, decreases the number of tokens processed by the generative AI model, and thereby reduces inference time and memory usage.

The server further improves accuracy by applying a consistency checking algorithm to the generated explanatory document before storage. The server parses the generated text using a rule-based parser to locate numeric expressions and cross-checks them against the original structured reporting information. When the server detects discrepancies beyond a threshold (for example, numeric differences greater than a specified percentage), the server discards or regenerates the affected portions by issuing a corrective prompt sentence that instructs the generative AI model to preserve given numeric values. This reduces the probability of incorrect numerical statements and improves the reliability of the generated documents. The terminal receives explanatory documents and status information via the communication network. The terminal renders the explanatory document in a structured layout including sections such as risk overview, budget summary, and action items. The terminal also displays the tendency information for the primary evaluator as a visualization, such as a bar chart or badge labels, enabling the user to understand the emphasis applied during generation. The terminal provides input elements for the user to issue approval instructions or revision instructions. The terminal compresses interaction data and uses asynchronous communication methods to reduce network traffic and latency.

The user operates the terminal to view explanatory documents and to provide feedback. The user may, for example, select a specific section of the explanatory document and input a textual comment clarifying the desired revision. The user may also specify revision options such as “add more detail on equipment safety interlocks” or “simplify explanation for non-technical stakeholders.” The terminal transmits these inputs as structured response information to the server, including section identifiers and revision tags.

The server uses these detailed revision tags and section identifiers to construct partial prompt sentences that instruct the generative AI model to regenerate only the relevant portions of the explanatory document. For example, the server may generate a prompt sentence of the following form:

“Rewrite only the ‘Risk Overview’ section of the following approval explanation. The approver requested a simpler explanation suitable for non-technical managers and more detail on equipment safety interlocks. Keep all budget figures unchanged and keep the total length within 300 words. Original section: [risk overview section text]. Additional data: [equipment safety interlock list].”

By limiting regeneration to specific sections, the server minimizes required computation and reduces the risk of inadvertently altering unrelated sections. This sectional regeneration behavior is implemented through an internal data structure that stores section-level offsets and identifiers for each explanatory document. The server updates only the modified sections in the generated document table and maintains version history for each section.

The server calculates evaluator tendencies using a machine learning training process that runs offline or periodically. In one embodiment, the server trains a multi-label classifier based on a neural network. The neural network may include an input layer receiving TF-IDF features or contextual embeddings, one or more hidden layers with rectified linear unit activation functions, and an output layer producing scores between 0 and 1 for each focus dimension. The server uses a loss function such as binary cross-entropy computed over all focus dimensions and updates weights using a gradient-based optimizer. The server may perform regularization techniques, such as dropout, to prevent overfitting. The server stores trained weight parameters in the storage device and loads them into memory at runtime for inference. The server may also use a sequence classification neural network, such as a transformer encoder, to directly map comment text to tendency scores. In such an embodiment, the server feeds tokenized comments into the encoder, extracts a pooled sequence representation, and applies a linear classification head. The server trains this model using labeled evaluator comments and a loss function such as categorical cross-entropy or mean squared error, depending on the representation of ground-truth tendencies. This allows the server to capture long-range dependencies and context in the comments more effectively than simple bag-of-words models, thereby improving the accuracy of tendency information.

The server improves computer technology by optimizing how complex, heterogeneous reporting data and user-specific tendencies are transformed into compact, high-utility prompts for a generative AI model. Unlike conventional systems that simply pass large sets of unfiltered text or tables, the server performs structured selection, normalization, and compression based on formally represented stage requirements and evaluator profiles. This reduces the size of data transmitted to the model serving system and lowers computational load both in the server and in the generative AI model. As a result, the server achieves faster response times, lower memory consumption, and reduced network bandwidth usage, particularly when processing many approval cases in parallel.

The server further improves data management by maintaining explicit relationships between stages, mandatory items, collected data, profiles, and generated documents through normalized database schemas. This structured representation enables efficient indexing and querying, reduces duplication, and supports scalable retrieval operations when searching historical cases. When the server generates integrated summary information across multiple past cases, the server first performs a similarity search over the explanatory documents using vector embeddings or keyword indices. The server then selects representative excerpts and constructs a prompt sentence instructing the generative AI model to compare and contrast these excerpts. This combination of structured pre-filtering and generative summarization allows the server to produce concise analytic outputs with fewer model invocations. The terminal, by rendering evaluator-aware summaries and integrated historical insights, allows the user to make decisions with fewer repeated document views and less manual cross-reference. The reduction in user-driven iterations also translates into fewer server requests, reducing overall system load. The technical effect is not limited to business workflow efficiency; rather, the architecture directly improves the way the server processes, filters, and compresses information, leading to quantifiable resource savings and improved throughput for document generation and retrieval tasks.

In another embodiment, the server may be deployed in a distributed environment where different modules, such as the data acquisition module, the natural language processing module, and the model interaction module, execute on separate physical machines. The server uses message queues or remote procedure calls to coordinate processing. The same data structures, such as stage definitions, tendency information, and document versions, are shared through a centralized database or a distributed storage system. This configuration allows horizontal scaling and load balancing, which further enhances performance when handling large numbers of approval procedures.

In still another embodiment, the terminal may be a handheld device or an industrial control panel display located near physical equipment. The server may incorporate real-time sensor data from equipment into reporting information. For instance, the server may retrieve sensor logs indicating vibration levels, temperature, or cycle counts, structure these logs, and pass them through the same pipeline for explanation and risk assessment. By integrating real-time equipment data, the server not only supports decision making but also participates in equipment monitoring workflows. The same technical mechanisms for structured data selection, profiling, and prompt generation reduce the volume of sensor data that needs to be interpreted by human operators, providing an additional technical effect in terms of improved monitoring efficiency.

The described embodiments may be implemented with different specific software libraries, database engines, and generative AI model deployments. The server may interact with an external model provider via a standardized API or may host an internal model instance. The generative AI model may be replaced by alternative generative architectures, including recurrent neural networks or other sequence-to-sequence models, provided that the server still generates and transmits prompt sentences and structured data in accordance with the described method. The use of different libraries or hardware platforms does not depart from the scope of the present embodiments as long as the core functional relationships-stage-aware data structuring, evaluator profiling, optimized prompt generation, and controlled document generation and revision—are maintained.

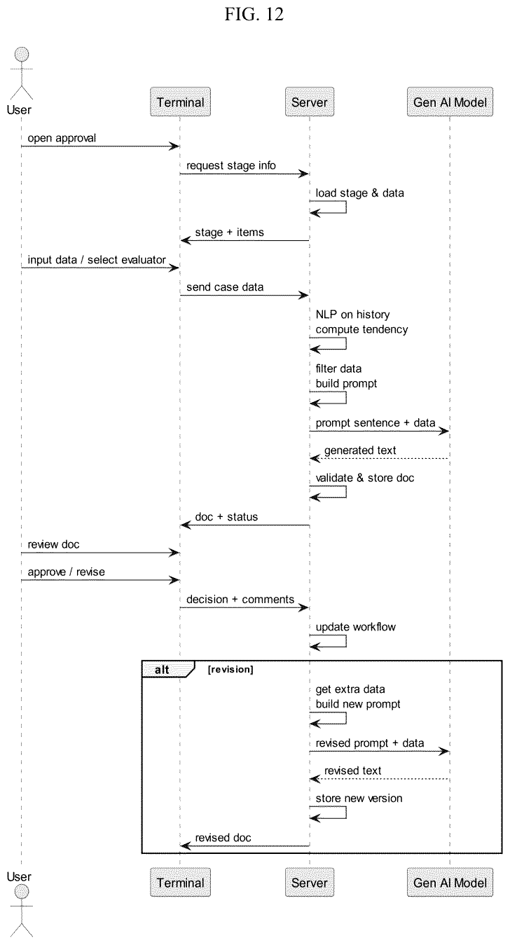

The following describes the processing flow using FIG. 12.

### Step 1:

The server acquires stage information and mandatory reporting items from the storage device. The server receives, as input, a stage identifier and an approval case identifier from the terminal via a request.

The server queries the database using the stage identifier to retrieve records from a stage definition table and a mandatory item table.

The server loads the query results into in-memory data structures, normalizes field names, and organizes them into a list of mandatory reporting items associated with the stage.

The server outputs structured stage metadata and a mandatory item list to subsequent modules.

### Step 2:

The server collects and structures reporting information required for the stage.

The server receives, as input, the mandatory item list and the approval case identifier from Step 1.

The server determines for each mandatory item whether data is already stored in the collected data table or must be obtained from external systems.

The server issues database queries or external system calls (for example, to production management or cost management systems) to retrieve raw data corresponding to each mandatory item.

The server loads raw data into tabular data structures, performs data cleaning operations such as type conversion, missing value handling, and unit normalization, and aggregates values using predefined aggregation functions (for example, sum, average, minimum, maximum). The server outputs a set of structured reporting information records, keyed by the approval case identifier and mandatory item identifiers.

### Step 3:

The server retrieves evaluator information and evaluation history data.

The server receives, as input, an evaluator identifier associated with the current approval stage.

The server queries the reviewer profile table and the evaluation history table using the evaluator identifier to obtain comment texts, decision logs, and metadata such as timestamps and associated stages.

The server organizes the retrieved comments into a chronological sequence and groups the records by evaluation category.

The server outputs a collection of evaluation history records and associated metadata for use in profile generation.

### Step 4:

The server analyzes evaluation history data by a natural language processing technique and generates tendency information.

The server receives, as input, the evaluation history records from Step 3.

The server tokenizes each comment text, removes stop words, performs lemmatization, and extracts textual features such as word n-grams or contextual embeddings.

The server applies a trained classifier or regression model to the extracted features to compute numerical scores representing focus dimensions (for example, safety focus, quality focus, cost focus, schedule focus).

The server aggregates scores across multiple comments using statistical operations such as averaging and variance calculation to obtain stable tendency values for each dimension. The server stores the resulting tendency information in the reviewer profile table and outputs the tendency information as a feature vector for use in prompt generation.

### Step 5:

The server selects and filters reporting information based on stage definition and tendency information.

The server receives, as input, the structured reporting information from Step 2 and the tendency information from Step 4.

The server evaluates the importance of each reporting item by combining stage-specific importance weights and evaluator focus scores.

The server filters out reporting items whose combined importance score is below a threshold and ranks remaining items according to their scores.

The server compresses numerical tables by selecting relevant rows and columns, and summarizes textual fields by extracting key sentences using a text-ranking algorithm. The server outputs a reduced and prioritized set of reporting data to be embedded in the prompt sentence.

### Step 6:

The server constructs a prompt sentence for the generative AI model.

The server receives, as input, the reduced reporting data, the tendency information, and the stage metadata.

The server generates an instruction segment that describes the task (for example, generate approval summary, emphasize specific focus areas, constrain length).

The server converts the reduced reporting data into a textual representation, such as formatted tables or bullet lists, and appends this representation as a data segment.

The server inserts phrases derived from the tendency information indicating which aspects should be emphasized, and combines the instruction segment, context segment, and data segment into a single prompt sentence.

The server outputs the final prompt sentence and an associated structured data bundle for use by the generative AI model.

### Step 7:

The server invokes the generative AI model to generate an explanatory document.

The server receives, as input, the prompt sentence and the structured data bundle from Step 6.

The server tokenizes the prompt sentence using a model-specific tokenizer and arranges tokens into an input sequence suitable for the transformer-based neural network.

The server sends the token sequence and generation parameters (for example, temperature, maximum output length, sampling settings) to the generative AI model via a model serving interface.

The server receives, as output, a sequence of generated tokens from the generative AI model and decodes the tokens into natural language text.

The server outputs the generated explanatory document text for validation and storage.

### Step 8:

The server validates and stores the generated explanatory document.

The server receives, as input, the explanatory document from Step 7 and the original structured reporting data.

The server parses the explanatory document to detect numeric expressions and references to key figures, and cross-checks these values against the original data using comparison rules. The server identifies inconsistencies beyond a predefined tolerance, and if inconsistencies exist, the server may generate a corrective prompt sentence and invoke the generative AI model again to correct specific portions.

The server annotates the explanatory document with metadata such as generation time, model identifier, and validation results, and stores the document and metadata in the generated document table.

The server outputs a validated explanatory document identifier and associated metadata for presentation and workflow control.

### Step 9:

The server prepares presentation information for the terminal.

The server receives, as input, the approved explanatory document identifier, stage information, tendency information, and workflow status information.

The server retrieves the explanatory document, selects key sections, and generates a summary segment if necessary, such as an abstract or bullet-point list of main findings. The server prepares a display payload that includes the full explanatory document, the summary segment, evaluator tendency indicators, and current status of the approval case. The server formats the payload as a structured response and transmits it to the terminal via the communication network.

The server outputs rendered data structures ready to be displayed on the terminal.

### Step 10:

The terminal renders the explanatory document and receives user input.

The terminal receives, as input, the display payload from Step 9.

The terminal parses the payload and maps each segment to user interface components, such as text areas for document sections, charts for numerical summaries, and labels for status and evaluator tendencies.

The terminal renders the explanatory document, summary, and status on the display unit and activates input controls for approval and revision instructions.

The terminal collects user actions, such as button clicks and text entries, as structured input including approval type, comments, and references to specific sections.

The terminal outputs a response message containing the user's approval instruction or revision instruction to the server.

### Step 11:

The user reviews the explanatory document and issues an instruction.

The user receives, as input, the displayed explanatory document and associated summaries on the terminal.

The user reads through sections such as risk overview and budget summary, and assesses whether the information is sufficient and accurate for decision making.

The user selects a control, for example an “Approve,” “Reject,” or “Request Revision” control, and optionally enters comment text specifying reasons or requested changes.

The user confirms the instruction, causing the terminal to package the user's selection and comments as response information.

The user outputs the final decision instruction through the terminal to the server.

### Step 12:

The server updates workflow status based on the user's instruction.

The server receives, as input, the response information from Step 10 and Step 11, including approval type, comments, and reference identifiers.

The server writes a new log entry to the workflow log table recording the instruction, the evaluator identifier, and the timestamp.

The server updates the workflow status table by changing the state of the approval case to an approved state, a rejected state, or a revision-requested state as indicated by the instruction.

The server may trigger follow-up actions, such as scheduling a next-stage review or initiating revision processing.

The server outputs updated status information and, if necessary, a trigger signal for revision-related processing.

### Step 13:

The server processes revision instructions and regenerates document sections.

The server receives, as input, a revision instruction and associated comments from Step 12.

The server parses the comments to identify referenced sections and specific topics, and matches them with section identifiers in the explanatory document.

The server acquires additional reporting information if requested in the revision instruction, such as more detailed metrics or updated data, and structures this additional information. The server constructs a new prompt sentence focused on the targeted sections, embedding the original section text, the revision request content, and the additional reporting information. The server sends the new prompt sentence to the generative AI model, receives updated section text, replaces the corresponding sections in the explanatory document, and stores a new version in the generated document table.

The server outputs a revised explanatory document ready to be presented again to the terminal.

### Step 14:

The server generates integrated summaries from multiple past cases when requested.

The server receives, as input, a request from the terminal specifying search criteria for past approval cases or a natural language query.

The server queries the database to identify past cases that match the criteria and retrieves explanatory documents and status information for those cases.

The server computes similarity scores between past cases and the current case using feature vectors derived from document embeddings or key statistics, and selects a subset of representative cases.

The server constructs a prompt sentence that instructs the generative AI model to summarize common points and differences among the selected cases, and embeds excerpts or condensed tables from the explanatory documents.

The server sends the prompt sentence and excerpts to the generative AI model, receives integrated summary text, and stores or directly returns this text to the terminal.

The server outputs an integrated summary document that helps the user compare cases with reduced manual review effort.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In conventional approval workflows executed by information processing systems, processors typically store and display evaluator comment histories in a simple, chronological or document-based manner. Such systems treat evaluator comments as unstructured text and do not derive machine-usable profiles of evaluator tendencies. As a result, the systems fail to exploit accumulated review data to improve downstream processing. In particular, existing systems suffer from several technical problems in computer-based processing of review information.

First, conventional processors are not configured to automatically transform large-scale comment histories into structured representations that capture evaluator-specific patterns, such as frequently occurring terms, recurring evaluation targets, and sentiment tendencies. Without such structuring, the approval workflow system cannot systematically distinguish which evaluators emphasize which issues, and the system must repeatedly perform similar manual review operations, resulting in redundant processing and inefficient utilization of computing resources.

Second, conventional systems do not integrate natural language processing modules, sentiment analysis modules, and generative model interfaces in a coordinated manner at the system level. Even when a generative AI model is available, the processor typically forwards a generic prompt sentence that does not reflect evaluator-specific profiles or structured review data. This leads to generated documents that are poorly aligned with actual review practices, and forces users to perform extensive manual editing. From a computer-technical standpoint, this results in suboptimal use of model inference time, unnecessary iterations of generation, and increased network and storage load due to repeated document revisions.

Third, conventional processors do not automatically generate machine-readable and machine-renderable visualization data that reflects evaluator tendencies. Visualization, if performed, is often executed as a one-off manual task in separate tools, disconnected from the core approval workflow system. This lack of integrated visualization prevents the processor from using visual analytics as a feedback signal to adjust document generation behavior or to support efficient human-computer interaction, thereby limiting the ability of the system to reduce cognitive load on the evaluator.

Fourth, known systems do not provide a mechanism for dynamically constructing generative AI input, at runtime, by combining a user-specified prompt sentence with evaluator-specific opinion tendency profiles and structured approval-flow data. Consequently, the generative AI model cannot fully leverage the structured context accumulated in the system to produce tailored outputs. This leads to wasted computational effort within the generative model and, on the client side, additional processing and bandwidth consumption to manage multiple versions of inadequately tailored documents.

Therefore, there is a need for an improved computer-implemented system in which a processor automatically (i) extracts and structures evaluation information from a data storage device, (ii) analyzes evaluator comment histories by natural language processing and sentiment analysis to build persistent opinion tendency profiles, (iii) generates context-rich prompt sentences for a generative AI model based on these profiles and structured data, (iv) formats model outputs into standardized electronic documents, and (v) generates visualization data indicating evaluator tendencies. Such a system should improve the technical performance of the approval workflow platform itself, by reducing redundant computations, improving the relevance of generated content to evaluator behavior, streamlining document formatting processes, and enhancing the efficiency of human-machine interaction in review tasks.

The specific processing by the specific processing unit 290 of the data processing device 12 in Example 2 is realized by the following means.

The present invention provides a server comprising a processor configured to extract evaluation information related to approval procedures from a data storage device, convert the evaluation information into structured data including time information and identification information by using an information processing method, analyze comment histories of evaluators included in the structured data by using natural language processing processing and sentiment analysis processing to generate, for each evaluator, an opinion tendency profile indicating attention words, evaluation targets, and sentiment tendencies, generate a prompt sentence for instructing a generative AI model to generate a document by determining document structural elements for respective discussion points emphasized by the evaluator based on the opinion tendency profile and the structured data, supply, to the generative AI model, input information including the prompt sentence, the opinion tendency profile, and the structured data, acquire document text output from the generative AI model, automatically format the document text into a predetermined electronic document format by using an interface for document creation, and generate visualization data indicating the opinion tendencies of the evaluators based on the opinion tendency profile and the structured data.

This enables the approval workflow system to technically improve processing efficiency and output quality by allowing the processor to automatically derive evaluator-specific profiles from unstructured comment histories, to construct context-enriched inputs for the generative AI model so that the model produces documents that are better aligned with evaluator behavior, to reduce redundant manual editing and repeated generation cycles, to decrease computational and bandwidth overhead associated with poorly targeted document generation, and to provide integrated visualization outputs that support more efficient human-computer interaction during review operations.

The term “data storage device” refers to a hardware or software-based data holding component, such as a database system or file storage system, that stores evaluation information, structured data, and related approval workflow data in a machine-readable format.

The term “evaluation information” refers to data generated in connection with an approval procedure, including but not limited to evaluator comments, timestamps, identifiers of evaluators and workflows, and other metadata describing review actions and results. The term “approval procedure” refers to a computer-implemented workflow in which submitted information, documents, or proposals are reviewed and approved, rejected, or returned with comments by one or more evaluators according to predefined process rules. The term “structured data” refers to evaluation information that has been organized into a predetermined schema, including explicit fields for time information, identification information, and other attributes, so that the information can be processed programmatically by a processor.

The term “time information” refers to temporal data associated with evaluation information, including, for example, timestamps, dates, and time ranges indicating when a comment was created, modified, or associated with a step in an approval procedure.

The term “identification information” refers to data that uniquely or distinctively identifies entities involved in the approval procedure, such as evaluator identifiers, workflow identifiers, document identifiers, and other keys used to correlate records within the system. The term “natural language processing” refers to computerized processing techniques for analyzing and transforming human-language text, including operations such as tokenization, part-of-speech tagging, lemmatization, phrase extraction, and semantic analysis.

The term “sentiment analysis” refers to computerized techniques that assign sentiment or attitude values to text, such as positive, negative, or neutral scores, and that derive sentiment tendencies for evaluators or topics based on aggregated comment histories.

The term “opinion tendency profile” refers to a data structure stored by the system that represents, for each evaluator, patterns extracted from comment histories, including attention words, evaluation targets, and sentiment tendencies related to those targets.

The term “attention words” refers to words or phrases that occur with relatively high frequency or significance in an evaluator's comments and that indicate topics, issues, or aspects to which the evaluator repeatedly directs attention.

The term “evaluation targets” refers to specific categories, items, or aspects of reviewed content, such as risk, cost, schedule, quality, or compliance, that are identified from evaluator comments as subjects of evaluation or criticism.

The term “sentiment tendencies” refers to characteristic patterns of sentiment, such as consistently positive, consistently negative, or mixed attitudes, associated with an evaluator's comments about certain attention words or evaluation targets over time.

The term “prompt sentence” refers to a text input that instructs a generative AI model regarding a document generation task, and that may include context about an evaluator's opinion tendencies and structured data related to an approval procedure.

The term “generative AI model” refers to a machine learning model, such as a neural-network-based language model, configured to generate text in response to input data, including prompt sentences, profiles, and structured information supplied by the system. The term “document structural elements” refers to components that define the organization of a document, such as sections, headings, paragraphs, lists, and tables, which are determined by the processor based on evaluator-specific tendencies and approval requirements.

The term “input information” refers to a combination of data elements provided to the generative AI model, including at least a prompt sentence, an opinion tendency profile, and structured data related to an approval procedure.

The term “document text” refers to a sequence of natural-language characters generated by the generative AI model, which forms the substantive content of a document to be used in an approval procedure.

The term “interface for document creation” refers to an application programming interface, software library, or other programmable mechanism that allows the processor to automatically generate, format, and store electronic documents in a predetermined document format. The term “electronic document format” refers to a machine-readable file format that represents text and layout information, such as a word processing format, which can be displayed, stored, transmitted, and edited by computing devices.

The term “visualization data” refers to data prepared in a form suitable for graphical representation, such as numerical values, categorical labels, and coordinates, which indicate evaluator tendencies including attention words, evaluation targets, and sentiment tendencies. The term “display image data” refers to image or graphical data generated from visualization data, including charts, graphs, or diagrams, that can be rendered on a display device to visually present evaluator tendencies to a user.

In one embodiment, a server executes a computer program to implement the claimed system. The server includes at least one central processing unit (CPU), a main memory, a non-transitory storage device such as a magnetic disk or solid-state drive, and a network interface. The server is communicatively connected to a data storage device that implements a relational database management system such as a general-purpose relational database (for example, a structured query language database), and to one or more terminals via a communication network such as an IP network. Each terminal includes a processor, a memory, a display device, an input device, and a communication interface, and executes a web browser or a dedicated client application.

The server executes an operating system such as a general-purpose server operating system and an application program implementing the approval workflow processing. The server further executes an interpreter or runtime environment for a general-purpose programming language such as Python, and uses software libraries including a data analysis library (for example, a table-based data manipulation library such as pandas), a natural language processing library (for example, a library such as NLTK or spaCy), a visualization library (for example, a plotting library such as matplotlib or seaborn), and a document creation interface library (for example, an office document manipulation interface such as a word-processing document API). The server is also configured to access an external generative AI model provided as a network service, such as a transformer-based language model accessible via an HTTP-based application programming interface.

The server stores, in the data storage device, evaluation information related to approval procedures. The evaluation information includes evaluator comment texts, timestamps, evaluator identifiers, workflow identifiers, document identifiers, and additional metadata such as step numbers in the approval procedure. The evaluation information is stored as records in one or more database tables, each record including fields for time information and identification information. The server structures the evaluation information by reading the raw records and converting them into a tabular data structure, such as a table with columns for comment text, time information, evaluator identifier, workflow identifier, and derived fields.

The server maintains indices on the identification information fields in the database to improve search performance when retrieving and correlating approval-flow data. The server uses the data analysis library to transform the evaluation information into structured data. The server loads data from the database into an in-memory data structure such as a DataFrame, and performs schema normalization, such as standardizing time zones for all timestamps, normalizing evaluator identifiers to a canonical format, and flagging records associated with test workflows. The server fills missing fields according to predefined rules, such as substituting default values for missing evaluator identifiers, and discards records that do not satisfy completeness criteria. This pre-processing improves downstream computational efficiency by ensuring that subsequent natural language processing modules do not process malformed or irrelevant data.

The server applies natural language processing to the comment text fields to derive features that are not directly observable from raw text. The server uses a tokenization and linguistic analysis engine, such as a spaCy model, to segment each comment into tokens, assign part-of-speech tags, and compute lemmas. The server uses a stop-word list to discard function words and retain content-bearing tokens. The server further constructs n-gram sequences (for example, bigrams and trigrams) from lemmas, and stores the token sequences and n-grams as additional columns in the structured data. This structured linguistic representation of the evaluator comment histories enables the server to execute vectorized frequency computations and sentiment aggregation that would not be feasible on unstructured text alone. The server implements sentiment analysis by applying a sentiment scoring algorithm to each comment. In one embodiment, the server uses a lexicon-based sentiment analyzer such as a rule-based valence evaluation. The server assigns, to each comment, numerical sentiment scores including at least a compound score and partial scores for positive, neutral, and negative sentiment. These scores are stored in the structured data table as numeric fields. The server then aggregates the sentiment scores by evaluator identifier and by evaluation target categories to produce summary statistics such as mean sentiment per evaluator and per topic. By computing sentiment at the level of structured records and storing the resulting scores as indexed numeric fields, the server improves query performance and allows efficient computation of evaluator-specific sentiment tendencies over large volumes of historical data. The server generates, for each evaluator, an opinion tendency profile as a data structure that includes attention words, evaluation targets, and sentiment tendencies. The server constructs the profile by computing term frequencies over the lemma and n-gram columns, applying thresholds to select highly frequent terms, and clustering or grouping terms into evaluation target categories such as risk, schedule, cost, quality, and compliance. The server maintains, in the profile, counts and normalized frequencies for each attention word and evaluation target, as well as aggregated sentiment statistics for these categories. The server stores the opinion tendency profiles in a separate data storage structure as records keyed by evaluator identifier, such that subsequent operations can access profiles without reprocessing all comment histories.

The server uses visualization libraries to generate visualization data and corresponding display image data that represent evaluator tendencies. The server constructs intermediate visualization data structures, such as matrices of term frequencies per evaluator, vectors of average sentiment per target category, and time-series arrays for sentiment over time. The server then renders bar charts, line graphs, and heatmaps by mapping these arrays into coordinate spaces, assigning color values to sentiment levels or frequencies, and rasterizing or vectorizing the resulting graphical outputs. The server stores the resulting display image data in a file system or object store and records references to these files in the database. The server transmits the display image data to the terminal, and the terminal displays the images on its display device as charts, enabling the user to visually understand evaluator tendencies without manually calculating or plotting the underlying data.

The server generates prompt sentences for a generative AI model by combining opinion tendency profiles with structured data. The server executes a rule-based template engine that inserts evaluator-specific attention words and evaluation targets into generic instruction templates. For example, when the evaluator's opinion tendency profile indicates frequent negative comments about risk assessment and test coverage, the server generates a prompt sentence such as:

“Based on reviewer A's past comments, generate a comprehensive report draft that addresses risk management, test coverage, and justification of assumptions for the next approval stage.” The server may also generate other prompt sentences such as:

“Using reviewer A's historical comment tendencies, generate a draft status report that minimizes the chance of negative feedback in the next approval step.”

“Based on reviewer B's past focus on budget accuracy and cost control, create a financial summary for this quarter's approval review.”

“Referring to reviewers C and D's previous feedback on compliance and documentation quality, generate a template for an internal audit report for the upcoming approval flow.” In each case, the server programmatically selects the appropriate attention words and target categories from the opinion tendency profile and inserts them into the prompt sentence, so that the generative AI model receives context that is derived from data structures and not merely specified by the user in free-form text. This use of machine-generated prompt sentences improves the alignment between generative outputs and evaluator behavior, and reduces the need for repeated generation attempts, thereby decreasing computational load on the generative AI infrastructure.

The server communicates with the generative AI model via a network API. The server constructs input information that includes at least the prompt sentence, the opinion tendency profile, and the structured data. In one embodiment, the server encodes the profile and structured data into a textual context section that describes evaluator tendencies and relevant approval-flow facts, and concatenates this context with the prompt sentence. The server transmits the resulting input to a generative AI model that is implemented as a transformer-based neural network with an encoder-decoder or decoder-only architecture. The generative AI model includes multiple layers of self-attention and feed-forward networks, with trainable weight matrices representing token embeddings and internal representations of text. The model has been trained in advance on a corpus of generic text and, optionally, fine-tuned on domain-specific approval workflow documents.

The server benefits from the internal processing of the generative AI model, in which the model converts input tokens into high-dimensional vectors, applies non-linear transformations and attention mechanisms to derive context-aware token representations, and outputs a sequence of tokens representing the generated document text. The generative AI model uses hyperparameters such as number of layers, hidden dimension size, attention heads, learning rate, and batch size, and has been trained by minimizing a loss function such as cross-entropy between predicted tokens and ground-truth tokens, with weight updates performed by gradient descent or variants thereof. Although the training is performed offline, the structure and parameters of the model influence the inference-time behavior, ensuring that the prompts and evaluator-specific context yield coherent and contextually appropriate document text. The server receives the generated document text from the generative AI model as a sequence of tokens or characters, and reconstructs it into a text string. The server may apply post-processing rules, such as replacing or inserting standard section titles, enforcing maximum length per section, or adding organization-specific disclaimers. The server then uses the document creation interface to generate an electronic document in a word-processing format. The server programmatically creates paragraphs, headings, lists, and tables by mapping sections of the generated text to corresponding document structural elements. The server sets style attributes such as fonts, heading levels, and numbering schemes using the document API, and saves the resulting file in a storage location accessible by the terminals. The terminal accesses the server over the network and receives user interface data presented as web pages or application screens. The terminal displays lists of available evaluator profiles, generated documents, and visualization images. The user operates the terminal to select a target evaluator and a target approval procedure instance. The user can view the visualization images representing evaluator tendencies, and can select an option to generate a new report or template tailored to the evaluator. When the user wishes to add custom instructions, the user inputs a prompt sentence through an input field on the terminal. The terminal transmits the user-specified prompt sentence to the server, optionally combined with identifiers for the evaluator and workflow.

The server receives the user-specified prompt sentence and augments it with the opinion tendency profile and the structured data. The server dynamically generates the final input information for the generative AI model by appending context data to the user's text according to predetermined rules. For example, if the user specifies that the report should focus on compliance issues, the server retrieves the evaluator's sentiment tendencies and attention words related to compliance, and adds this information to the input. This dynamic composition of the input to the generative AI model constitutes a technical process that reduces trial-and-error on the part of the user and enables the server to generate highly targeted documents in fewer inference calls, which reduces usage of computational resources on the AI infrastructure and decreases network traffic associated with multiple generation requests.

The server thereby improves technical performance of the approval workflow platform in several ways. By storing evaluator-specific opinion tendency profiles as persistent data structures, the server avoids recomputing frequencies and sentiments for the entire comment history on each generation request, which reduces CPU load and accelerates response time. By using structured data and indexed fields, the server improves data management, enabling faster retrieval of relevant subsets of comments and associated metadata. By generating context-rich prompt sentences and supplying them along with structured data to the generative AI model, the server improves the precision of generated content, reducing the need to generate and transmit multiple document versions, and thereby decreasing network bandwidth consumption and storage overhead.

The server further reduces human error and variability in document preparation by enforcing rule-based construction of prompt sentences and document structures. Unlike simple automation of human tasks, the server applies non-human, algorithmic criteria-such as thresholds on term frequency, clustering of topics based on vector similarity, and quantitative sentiment thresholds—to derive evaluator profiles and to determine document structural elements. These criteria are not merely codifications of business rules but represent computational heuristics designed to optimize model input quality and system resource utilization.

In another embodiment, the server replaces or supplements the lexicon-based sentiment analysis with a neural network-based sentiment classifier, such as a recurrent neural network or transformer classifier trained to predict sentiment labels for comments. The server may use features derived from word embeddings or contextual representations, and may fine-tune the classifier on labeled comment data. The classifier is trained using a loss function such as cross-entropy and updates weights via backpropagation and gradient descent. By incorporating these learned sentiment scores into the opinion tendency profiles, the server can achieve higher accuracy in detecting evaluators' attitudes toward specific topics, which, in turn, improves the downstream selection of attention words and document emphasis. In a further embodiment, the server performs dimensionality reduction and clustering on the term-frequency vectors or embedding vectors for comments, using algorithms such as principal component analysis or k-means clustering. The server uses the clustering results to group similar comments and topics, and to derive higher-level evaluation targets. This unsupervised analysis enables the system to discover evaluator tendencies that may not be explicitly coded in business rules. By integrating these clusters into the profiles and prompt generation, the server enhances the adaptability of the system to changing review patterns without manual reconfiguration.

In yet another embodiment, the server is configured to adapt the prompt-generation rules based on feedback data. The server records, in association with each generated document, an evaluation of its usefulness, such as whether the evaluator provided significantly fewer negative comments compared to past reviews. The server then adjusts thresholds for including or excluding certain topics in the prompt sentences, or modifies weights assigned to sentiment versus frequency in determining attention words. This feedback loop constitutes an optimization of the prompt-generation algorithm, thereby further improving computational efficiency and the quality of generated documents without increasing human workload.

The above embodiments illustrate that the server does more than automate human drafting of reports. The server introduces specific data structures (structured tables, profiles, visualization arrays), specific algorithms (frequency analysis, sentiment aggregation, clustering, rule-based template filling), and specific interactions with a generative AI model (context-enriched input construction, constrained formatting) that improve the functioning of the computer system itself. These technical improvements manifest as faster processing times for generating tailored reports, reduced error in reflecting evaluator tendencies, more efficient use of network and storage resources, and enhanced usability of visualization outputs for human reviewers using terminals.

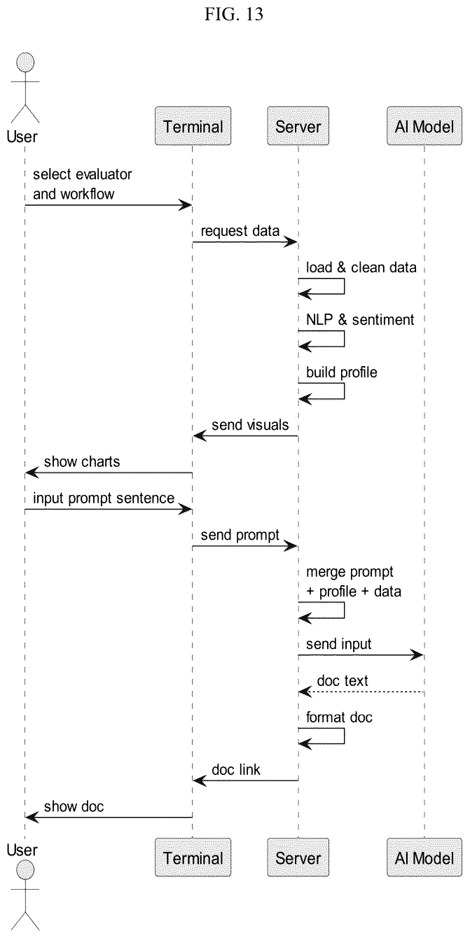

The following describes the processing flow using FIG. 13.

### Step 1:

The server retrieves raw evaluation information from the data storage device.

The server receives, as input, database connection parameters and query conditions such as date range, target approval procedure identifier, and evaluator identifier. The server sends a structured query to the relational database and obtains, as output, a result set that includes comment text, timestamps, evaluator IDs, workflow IDs, and related metadata. The server converts the result set into an in-memory tabular structure and stores it in working memory for subsequent processing.

### Step 2:

The server converts the raw evaluation information into structured data.

The server takes, as input, the in-memory tabular structure obtained in Step 1. The server applies schema normalization operations, such as converting all timestamp fields to a common time zone, trimming whitespace from text fields, and standardizing evaluator IDs to a consistent format. The server performs data cleaning operations, including filling missing evaluator IDs with a default identifier, discarding records with empty or invalid comment text, and flagging test records based on workflow ID patterns. The server outputs a cleaned, structured data set, for example a DataFrame, with defined columns for comment text, time information, identification information, and validity flags.

### Step 3:

The server performs natural language preprocessing on comment text.

The server receives, as input, the structured data set from Step 2. The server applies a natural language processing library to each comment text field to perform tokenization, part-of-speech tagging, and lemmatization. The server removes stop words and punctuation tokens, and generates token sequences and lemma sequences. The server stores these sequences in additional columns alongside the original text, and outputs an enriched structured data set containing both raw text and linguistic feature columns.

### Step 4:

The server computes term frequencies and identifies attention words and phrases. The server uses, as input, the enriched structured data set from Step 3. The server groups the data by evaluator ID and iterates over lemma sequences to count occurrences of each lemma and n-gram. The server calculates term frequency values and optionally normalized frequency values, such as term frequency per 1,000 tokens, for each evaluator. The server filters out terms whose frequencies fall below a predetermined threshold and sorts the remaining terms by frequency to identify attention words and key phrases. The server outputs, for each evaluator, a list or table of attention words and phrases with associated frequency statistics.

### Step 5:

The server performs sentiment analysis on the comments.

The server takes, as input, the original comment texts and evaluator IDs from the structured data set. The server applies a sentiment analysis algorithm to each comment to compute numerical sentiment scores, including at least a combined score and component scores for positive, neutral, and negative sentiment. The server writes these scores into new numeric columns in the structured data set. The server then aggregates the sentiment scores by evaluator and by category (such as evaluation target) to compute average sentiment, distribution of sentiment classes, and trend statistics. The server outputs sentiment-annotated structured data and aggregated sentiment statistics per evaluator.

### Step 6:

The server derives evaluation targets and constructs opinion tendency profiles. The server uses, as input, the attention words, term frequencies, and aggregated sentiment statistics. The server groups or maps attention words to evaluation target categories, such as risk, cost, schedule, quality, and compliance, according to predefined rules or clustering results. The server combines, for each evaluator, the list of attention words, their frequencies, associated target categories, and sentiment statistics into a unified data structure. The server stores this structure as an opinion tendency profile keyed by evaluator ID and outputs a collection of profiles that can be retrieved by other components.

### Step 7:

The server generates visualization data and display image data for evaluator tendencies. The server receives, as input, the opinion tendency profiles and, optionally, time-series sentiment data from the structured data set. The server constructs numerical arrays and matrices representing, for example, term frequency per evaluator, average sentiment per evaluation target, and sentiment trends over time. The server uses these arrays as plotting data to generate graphical objects such as bar charts, line graphs, and heatmaps. The server then renders these graphical objects into image data, such as PNG or SVG files, and stores file paths or identifiers in the data storage device. The server outputs references to the display image data for delivery to the terminal.

### Step 8:

The terminal requests and displays evaluator tendency visualizations.

The terminal sends, as input, a request message specifying an evaluator ID or workflow ID to the server. The terminal receives, as output, metadata and file locations for the display image data created in Step 7. The terminal downloads the image data and renders the charts on its display device. The terminal may allow the user to select specific evaluators or time ranges, and then dynamically updates the display based on the user's choices and additional image data retrieved from the server.

### Step 9:

The user selects an evaluator and an approval procedure context.

The user operates the terminal to choose, as input, one or more evaluator identifiers and an approval procedure identifier from a list or search interface displayed on the terminal. The user confirms the selection by interacting with a graphical control such as a button or menu option. The terminal sends the selected identifiers to the server as output in a request message, thereby specifying the context for subsequent document generation.

### Step 10:

The server generates a system-derived prompt sentence based on the opinion tendency profile. The server receives, as input, the evaluator identifier and approval procedure identifier from the terminal, and retrieves the corresponding opinion tendency profile and structured data. The server applies a rule-based template engine, which inserts attention words, evaluation targets, and sentiment characteristics extracted from the profile into pre-defined prompt patterns. As a result, the server constructs a prompt sentence that describes the desired document content and emphasizes evaluator-specific concerns. The server outputs one or more generated prompt sentences suitable for use with a generative AI model, and may store them in association with the approval procedure instance.

### Step 11:

The user optionally inputs a custom prompt sentence.

The user views, on the terminal, an input field where text instructions can be provided. The user may type, as input, a prompt sentence such as “Based on reviewer A's past comments, generate a comprehensive report draft that addresses risk management, test coverage, and justification of assumptions for the next approval stage.” The terminal transmits this user-specified prompt sentence to the server as output, together with the selected evaluator and approval context, enabling the server to combine user instructions with system-derived context.

### Step 12:

The server constructs final input information for the generative AI model.

The server takes, as input, the system-derived prompt sentence, the user-specified prompt sentence (if present), the opinion tendency profile, and relevant structured data pertaining to the approval procedure. The server merges these components according to predetermined rules, such as appending a profile summary and data-derived context before or after the prompt sentence, and resolving conflicts between system and user instructions. The server packages the resulting composite text as input information for the generative AI model and outputs a formatted request body suitable for an AI model API.

### Step 13:

The server sends the input information to the generative AI model and receives document text. The server provides, as input to an external generative AI model, the composite text created in Step 12. The server calls the AI model's network endpoint, sending model configuration parameters and the input information. The generative AI model processes the tokens, performs internal computations based on its trained parameters, and returns an output sequence of tokens representing generated document text. The server receives this sequence as output, reconstructs it into a human-readable text string, and stores the text for further processing.

### Step 14:

The server post-processes the generated document text.

The server takes, as input, the raw generated text from the generative AI model and the opinion tendency profile for the relevant evaluator. The server parses the text to detect headings, paragraphs, and lists, and checks whether key evaluation targets from the profile are addressed. If certain mandatory topics are missing or insufficiently covered, the server can insert additional boilerplate sections or annotations based on rule-based logic. The server normalizes formatting markers and adds meta-information such as document title and approval stage. The server outputs a refined document text that conforms to internal structural requirements.

### Step 15:

The server formats the refined document text into an electronic document.

The server uses, as input, the refined document text from Step 14. The server invokes a document creation interface to generate an electronic document in a word-processing format, programmatically creating a document object, inserting headings, paragraphs, bullet lists, and tables, and applying style settings referenced from predefined templates. The server then saves the document file to a storage location, records its identifier and metadata (such as evaluator ID and creation time) in the data storage device, and outputs a reference (for example, a document ID or download URL) for use by the terminal.

### Step 16:

The terminal retrieves and presents the generated document to the user.

The terminal sends, as input, a request containing the document reference from Step 15 to the server. The terminal receives, as output, the electronic document file or a download stream from the server. The terminal stores the file locally or in a temporary cache and opens it with installed office software or an embedded viewer. The terminal displays the formatted document on the display device, allowing the user to scroll through sections, review content, and make manual edits if necessary.

### Step 17:

The user reviews and optionally edits the generated document.

The user views, on the terminal, the generated report or template created for the selected evaluator and approval stage. The user may modify specific sections, adjust wording, or insert additional data using document editing functions provided by the office application. After completing review and edits, the user saves the updated document and, if desired, uses a separate interface to submit the document back into the approval procedure workflow.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional approval and reporting systems typically focus on automating form filling or document routing while treating all evaluators and users in a uniform manner. In such systems, a processor may retrieve fixed sets of fields from a data store and may render static templates, but the processor generally does not adapt document structure, content selection, or interaction flow based on evaluator tendencies, user preferences, or user emotional states. As a result, the processor often generates documents that contain either excessive or insufficient detail for a given evaluator, thereby degrading comprehension and requiring additional manual clarification, which increases latency and computational load associated with repeated revisions and re-submissions.

Furthermore, existing generative AI integrations are usually implemented as simple text generation calls driven by manually crafted prompts. These systems do not systematically derive prompt sentences from machine-readable profiles of evaluator tendencies, user preferences, and real-time emotion information. Because the prompt sentences are not dynamically optimized based on system performance metrics, generative AI models may produce outputs that are verbose, poorly structured, or misaligned with the approval context. This in turn causes additional processing cycles for post-editing and re-generation and does not improve core computer functionality, such as efficient use of processing resources and storage bandwidth.

In addition, many workflow engines treat an approval flow as a fixed graph of steps, regardless of user cognitive load or stress level. The processor may present the same number of stages and the same volume of information to all users, causing unnecessary interaction steps and user-interface rendering operations when the user is under high load. Conversely, the processor may fail to expose sufficient detail when bandwidth and cognitive capacity are available, forcing users to perform manual database queries or document retrieval operations. These limitations result in suboptimal utilization of computational resources, increased network traffic due to repeated user requests, and higher end-to-end processing time for approvals and reviews.

There is therefore a need for an improved computer-implemented system in which a processor automatically acquires and fuses evaluator behavior data, user behavior data, and multimodal user state data, and uses this fused data to (i) compute control information for dynamically restructuring an approval flow, and (ii) algorithmically synthesize prompt sentences for a generative AI model. By doing so, the processor can automatically adjust document generation, summarization, and presentation at runtime, thereby reducing the number of interactions, improving cache and database access locality, and optimizing the computational cost of natural language generation and processing. The technical problem to be solved is to improve the functioning of the computer system itself specifically, to improve how the processor generates and manages approval documents and workflows—by reducing redundant processing, decreasing end-to-end latency, and NOBbIming the relevance and compactness of generated outputs through adaptive prompt generation and dynamic flow control.

The specific processing by the specific processing unit 290 of the data processing device 12 in Application Example 2 is realized by the following means.

The present invention provides a server comprising a processor and a storage device, the processor being configured to execute instructions that cause the processor to: extract business-related information from the storage device and integrate and structure the business-related information using an information processing method; analyze an evaluation history of an evaluator using a language processing method and generate and record evaluation tendency information indicating elements emphasized by the evaluator; analyze an operation history and a response history of a user and generate and record user preference information indicating an information format and a level of detail preferred by the user; analyze user state data acquired from an image acquisition apparatus and an audio acquisition apparatus using an emotion recognition method and generate and record emotion information indicating an emotional state of the user; refer to process-stage information in an approval process, the evaluation tendency information, the user preference information, and the emotion information, and generate approval-flow control information that defines information items to be reported in the approval process and a presentation order, a level of detail, and explanatory content of the information items; generate a document template based on the approval-flow control information and the integrated and structured business-related information, and generate base document data by embedding the business-related information into the document template; generate a prompt sentence as an instruction text for input to a generative model based on the base document data, the evaluation tendency information, the user preference information, and the emotion information, and transmit the prompt sentence to a generative AI model included in the generative model to automatically generate generated document data serving as an approval report document or an operational report document; analyze the generated document data using the language processing method, extract important information, and generate summarized document data according to an understanding level of the evaluator or the user; present the summarized document data and the generated document data on a display apparatus based on the approval-flow control information, acquire an approval operation, a correction operation, and feedback information from the evaluator or the user, and record the feedback information in the storage device; and update, in a learning manner, the evaluation tendency information, the user preference information, the emotion information, and generation rules of the prompt sentence based on the feedback information and a processing result. This enables the server to dynamically tailor approval flows and document generation to evaluator tendencies, user preferences, and user emotional states, thereby reducing redundant computation and interactions, shortening end-to-end approval latency, and improving core computer functionality in document generation, natural language processing, and workflow control through adaptive prompt sentence generation for the generative AI model.

The term “processor” refers to a hardware computation unit, such as a central processing unit or a programmable logic device, that executes machine-readable instructions to perform logical, arithmetic, and control operations.

The term “storage device” refers to a hardware data storage resource, such as a memory subsystem or a database system, that stores digital information including business-related information, histories, control information, and generated documents.

The term “business-related information” refers to digital data describing operational activities or workflows of an organization, including but not limited to approval data, project data, financial data, quality data, and transaction data.

The term “information processing method” refers to a computational technique for transforming raw data into structured data, including operations such as extraction, integration, normalization, aggregation, and formatting.

The term “language processing method” refers to a computational technique for analyzing or generating human language text, including tokenization, parsing, semantic analysis, summarization, and similar natural language processing operations.

The term “evaluation history” refers to stored digital records of past evaluations, comments, feedback, or review actions performed by an evaluator on documents or workflows.

The term “evaluator” refers to a human or automated review agent that examines generated documents or workflows and performs actions such as approval, rejection, or commentary. The term “evaluation tendency information” refers to data indicating patterns or preferences in an evaluator's past behavior, including elements or topics that the evaluator frequently emphasizes or requests.

The term “operation history” refers to digital records of user interactions with a system interface, including inputs, selections, navigation paths, and timing information. The term “response history” refers to digital records of user outputs, such as textual feedback, ratings, or choices, that indicate user reactions to displayed content or system behavior. The term “user preference information” refers to data indicating a user's favored formats, structures, or levels of detail for presented information, inferred from the operation history and the response history.

The term “image acquisition apparatus” refers to a hardware device, such as a camera, that captures visual data representing a user's face, body, or surroundings.

The term “audio acquisition apparatus” refers to a hardware device, such as a microphone, that captures sound data including a user's voice.

The term “user state data” refers to multimodal digital data obtained from sensors, including visual data, audio data, and optionally textual or interaction data, that describe a current condition of a user.

The term “emotion recognition method” refers to a computational technique that analyzes user state data to estimate an emotional state, such as stress, confusion, satisfaction, or neutrality. The term “emotion information” refers to data indicating an estimated emotional state of a user, including an emotion label, an intensity level, and optionally a confidence value. The term “process-stage information” refers to data that define a current position or step within an approval process, including stage identifiers, required actions, and dependencies. The term “approval process” refers to a sequence of computationally represented stages in which data or documents are evaluated and decisions such as approval or rejection are made. The term “approval-flow control information” refers to data that define configuration of an approval process, including information items to be reported, their presentation order, levels of detail, and explanatory content.

The term “information item” refers to an atomic unit of information to be included in a document or user interface, such as a field, a metric, a paragraph, or a section.

The term “presentation order” refers to an arrangement of information items in a sequence or layout used when displaying information to an evaluator or a user.

The term “level of detail” refers to a degree of granularity or completeness with which an information item is described or expanded in a document or interface.

The term “explanatory content” refers to descriptive text or guidance that clarifies the meaning, context, or implications of an information item.

The term “document template” refers to a generic structural pattern or layout that specifies arrangement of sections, headings, and placeholders for business-related information in a document.

The term “base document data” refers to a partially completed document in which structured business-related information has been embedded into a document template before further processing.

The term “generative model” refers to a computational model that produces new data, such as text, from input conditions or instructions.

The term “generative AI model” refers to an artificial intelligence model, such as a trained neural network, that generates natural language text or other content in response to input instructions.

The term “prompt sentence” refers to an instruction text that specifies constraints, context, and desired output characteristics for input to a generative model.

The term “generated document data” refers to text or document content that is automatically created by the generative AI model in response to a prompt sentence.

The term “approval report document” refers to a document that describes content, rationale, and outcomes related to an approval process.

The term “operational report document” refers to a document that summarizes operational metrics, events, or statuses related to business activities.

The term “important information” refers to content within generated document data that is determined, by language processing or predefined rules, to be highly relevant to decision-making or understanding.

The term “summarized document data” refers to a condensed representation of generated document data in which important information is preserved while less critical detail is omitted or reduced.

The term “understanding level” refers to an estimated capacity or need of an evaluator or a user to comprehend information, used to adjust complexity and length of presented content. The term “display apparatus” refers to a hardware output device, such as a monitor or a mobile display, that visually presents document data and user interface elements. The term “approval operation” refers to an input action by which an evaluator or a user indicates acceptance or authorization of a document or process stage.

The term “correction operation” refers to an input action by which an evaluator or a user modifies, edits, or annotates content of a document.

The term “feedback information” refers to data provided by an evaluator or a user that indicate evaluation, comments, preferences, or other reactions to documents or system behavior.

The term “processing result” refers to an outcome of system operations, including generated documents, approval decisions, processing times, and associated performance metrics. The term “generation rules of the prompt sentence” refers to computational rules or parameters that determine content, structure, and style of a prompt sentence created for the generative model.

The term “learning manner” refers to an adaptive update process in which stored information or rules are modified based on data, such as feedback information and processing results, using statistical or machine learning techniques.

The term “processing time of the approval process” refers to a duration between initiation of an approval process or stage and completion of a corresponding approval decision.

The term “understanding-level index” refers to a quantitative measure derived from behavior or interaction data that estimates how well an evaluator has understood presented information. The term “satisfaction index” refers to a quantitative measure derived from feedback or behavior that estimates a user's satisfaction with documents, interfaces, or system responses. The term “high-load state” refers to a user condition in which cognitive or emotional load is inferred to be relatively high, such as when stress or confusion is detected.

The term “low-load state” refers to a user condition in which cognitive or emotional load is inferred to be relatively low, such as when calmness or confidence is detected. The term “approval procedure” refers to a computer-implemented sequence of interactions, computations, and decisions carried out to complete an approval process.

In one embodiment, a server executes computer programs that implement the claimed system using general-purpose computing hardware and standard software components configured in a specific architecture. The server includes at least one processor, a main memory, a non-volatile storage device, and a network interface. The server communicates with one or more terminals via a communication network. Each terminal includes a display device, an input device, an image acquisition apparatus such as a camera, and an audio acquisition apparatus such as a microphone. A user interacts with the system through the terminal.

The server uses an operating system and an application runtime such as a virtual machine or an interpreter. The server executes application programs written, for example, in a high-level programming language and uses software libraries for data processing and machine learning, such as a numerical computation library, a data-frame library, a template engine, and a natural language processing library. The server stores business-related information, evaluation histories, user histories, emotion information, and control information in a database system such as a relational database or a key-value store. The server accesses the database using a database driver and structured query language statements.

The server stores and executes several functional modules implemented as software components. A data extraction module controls retrieval of business-related information from the database. A language processing module controls analysis of text data and generation of summaries. An emotion recognition module controls processing of image and audio data to estimate emotion information. A preference analysis module controls extraction of features from operation history and response history. A control information generation module controls computation of approval-flow control information. A template generation module controls creation of a document template and base document data. A prompt generation module controls generation of a prompt sentence. A generative AI module interface controls communication with a generative AI model, such as a transformer-based sequence-to-sequence model executing on a remote computing system. A feedback learning module controls updating of evaluation tendency information, user preference information, emotion information, and generation rules of the prompt sentence.

The terminal uses its camera and microphone to acquire image and audio data representing the user's face and voice while the user operates the approval process interface. The terminal encodes the image data in a compressed format and the audio data in a digital audio format. The terminal transmits the data to the server via the network using a communication protocol such as HTTPS. The terminal receives document data and control information from the server and renders a user interface on the display device using graphical components. The terminal displays generated document data and summarized document data, as well as controls for approval, correction, and feedback. The user operates the terminal using pointing devices, a keyboard, or touch input to provide approval operations, correction operations, and feedback information.

The server structures business-related information internally as records and tables that are suitable for efficient processing. For example, the server represents business-related information as relational tables with fields for project identifiers, cost values, time stamps, and status codes. The server extracts necessary subsets of this information for a particular approval process using indexed queries, thereby reducing unnecessary data access and improving cache locality. The server converts the query results into in-memory data structures, such as columnar arrays or data frames, and performs normalization, aggregation, and transformation operations. This pre-processing improves the input quality for downstream modules, reduces dimensionality, and minimizes redundant computation in the generative AI model.

The server analyzes evaluation history text using the language processing module. The server tokenizes text into word tokens, normalizes the tokens, and builds feature vectors such as term frequency-inverse document frequency vectors for each evaluator. The server applies dimensionality reduction techniques or clustering algorithms to identify topics and recurrent patterns in the comments. The server then maps these patterns to a compact evaluation tendency representation, for example a vector in a low-dimensional space where each dimension corresponds to a focus type such as quantitative analysis, risk emphasis, schedule emphasis, or usability emphasis. By storing this vector representation in the database, the server can perform efficient lookups and similarity computations when composing new documents. This specific structuring of evaluator tendencies enables the server to adjust document generation in a machine-efficient way and reduces the need for manual rule configuration.

The server analyzes operation history and response history of a user using the preference analysis module. The server records, for example, which sections of documents the user expands or collapses, how long the user scrolls in each section, and which display options (tables, charts, long text, bullet lists) the user chooses when such options are available. The server encodes these observations as numerical feature vectors per user, such as counts of interactions with each content type and time-based engagement signals. The server applies a machine learning classifier or regressor, for example a small fully connected neural network, to estimate a user preference vector indicating weights for content types, target summary length ranges, and explanatory depth. This precomputed user preference vector allows the server to modulate summary generation and prompt construction with minimal additional computation.

The server processes user state data using the emotion recognition module. The server uses an image-processing pipeline to detect a face region in each frame, extract key facial landmarks, and compute normalized facial embeddings. The server uses an audio-processing pipeline to compute features such as short-time energy, pitch contours, and spectral coefficients from the audio signal. The server provides the concatenated visual and audio features as input to an emotion classifier implemented as a neural network. In one example, the neural network includes a convolutional sub-network for images and a recurrent or temporal convolutional sub-network for audio, followed by a fully connected layer that outputs probabilities for emotion classes such as stress, confusion, neutrality, and positive state. The server trains this neural network in advance using supervised learning with a cross-entropy loss function, mini-batch gradient descent, and regularization techniques. During operation, the server only performs inference, which is optimized and quantized for low latency. The server records the resulting emotion information, including an emotion label and a confidence score, in the database in association with a user identifier and a time stamp. This representation of emotion information enables the control information generation module to adapt the approval flow at runtime without re-running expensive feature extraction on each interaction.

The server generates approval-flow control information using the control information generation module. The server retrieves process-stage information for the current approval process, including stage identifiers, mandatory information items, and dependency relations. The server combines this with the evaluation tendency vector, the user preference vector, and the emotion information. The server applies a rule-based engine or a small decision model that maps these inputs to an approval-flow configuration, which can be represented as a directed acyclic graph of stages. Each stage node contains references to information items, a presentation order, and parameters for level of detail and explanatory content. When the emotion information indicates a high-load state, the server prunes non-critical nodes from the graph and merges certain explanatory segments, which reduces the number of user interactions and display updates. When the emotion information indicates a low-load state, the server expands detail and attaches additional explanatory nodes. This dynamic graph construction is performed algorithmically and cached, thereby improving computational efficiency and reducing network traffic because fewer back-and-forth requests are required to fetch supplemental explanations.

The server generates a document template using the template generation module. The server selects a template pattern matching the type of approval process and maps each information item in the approval-flow control information to a template placeholder. The server fills the template with structured business-related information, applying formatting rules to generate tables, charts, and textual headers. The server produces base document data, which is a machine-readable representation of the partially completed document. This base document data is used to supply consistent and accurate factual content to the generative AI model, reducing the need for the generative AI model to infer or approximate values and thereby decreasing the probability of factual errors.

The server generates a prompt sentence using the prompt generation module. The server constructs the prompt sentence from multiple components: a description of the approval context, a list of required sections, a summary of evaluator tendencies, a summary of user preferences, an indication of emotion information, and a compact representation of key fields from the base document data. For example, the server generates a prompt sentence such as: “Using the following data and analysis, generate a customized approval report for project ID 12345.

Required sections: risk summary, budget breakdown, staffing plan, schedule.

The evaluator tends to request detailed quantitative analysis and sensitivity scenarios. The user prefers concise summaries with bullet points and is currently stressed. Write a clear and empathetic report, limit the executive summary to 200 words, then include a separate detailed annex.

Data and intermediate summary: [structured metrics and short sentences].”

In another example in a manufacturing scenario, the server generates a prompt sentence such as:

“Based on the following manufacturing data from line A over the last 2 hours, identify likely causes for the elevated defect rate and propose three practical corrective actions. Generate a quality management report suitable for a plant manager, and include a one-paragraph summary at the top.”

In a payment scenario, the server generates a prompt sentence such as:

“Use the following 30-day payment history and sentiment scores to generate a personalized transaction report. Highlight overspending on subscriptions, acknowledge the user's satisfaction with travel, and suggest two concrete saving strategies. Keep the tone friendly and encouraging.”

These prompt sentences are not static text but are algorithmically synthesized using the evaluation tendency information, user preference information, emotion information, and base document data. The server stores generation rules of the prompt sentence as parameter sets and templates that map feature vectors to textual instructions. The feedback learning module updates these generation rules over time by adjusting weights and selecting alternative phrasing patterns that historically produced more efficient approvals and higher satisfaction. This dynamic prompt construction mechanism directly improves the quality and relevance of generative AI outputs, reducing the number of required re-generations and thus the computational cost.

The server interfaces with a generative AI model through the generative AI module interface. In one embodiment, the generative AI model is a neural network based on a transformer architecture with multiple attention layers, pre-trained on large corpora and fine-tuned on domain-specific text. The server sends the prompt sentence and selected portions of the base document data as input tokens to the generative AI model and receives generated document data as output tokens. The server may specify decoding parameters such as maximum length, temperature, and repetition penalties. By providing structured and context-rich prompt sentences, the server constrains the generative AI model to produce outputs that are aligned with evaluator tendencies, user preferences, and emotion information, thereby reducing randomness and improving precision.

The server analyzes the generated document data using the language processing module. The server applies text segmentation and uses models to identify key sentences and phrases. The server constructs summarized document data that preserves critical information in a condensed form. The server uses the evaluator's understanding level index, if available, and the user preference information to determine target summary length and complexity. For evaluators familiar with the domain, the server may generate shorter summaries with more technical terminology, while for less experienced evaluators, the server may generate longer summaries with additional explanatory content. This adaptive summarization reduces cognitive load and, importantly, reduces the amount of data that must be transmitted to and rendered on the terminal, thereby improving network and rendering performance.

The terminal presents the generated document data and the summarized document data based on the approval-flow control information. The terminal arranges sections in the specified presentation order and controls expansion or collapse of detailed content according to the level of detail parameter. The terminal also displays, when present, additional prompt sentences generated for the evaluator or user, such as short hints about where to focus in the document or what to verify. The user reviews the presented content and issues approval operations or correction operations through the terminal. The terminal transmits these operations together with feedback information to the server, which records them in the storage device.

The feedback learning module uses the feedback information and processing result to update stored information and the generation rules of the prompt sentence. The server monitors performance indicators such as processing time of the approval process, rate of rejections or major corrections, and satisfaction index values extracted from textual feedback. The server applies machine learning techniques, such as gradient-based optimization or bandit algorithms, to adjust internal prompt construction parameters. For example, when a certain style of prompt sentence leads to faster approvals and fewer corrections, the server increases its weight in the generation rules. When a particular pattern correlates with confusion or low satisfaction, the server decreases its weight or disables it. This closed-loop adaptation modifies internal data structures and algorithms in the server, improving computational efficiency and the relevance of generated documents.

The described configurations and processing flows provide technical effects beyond simple automation of human tasks. By representing evaluator tendencies, user preferences, and emotion information as compact numerical vectors and explicitly encoding them in approval-flow control information and prompt sentences, the server reduces redundant natural language processing and generative operations. This leads to decreased usage of processor cycles and memory bandwidth. By dynamically pruning or expanding stages in the approval process graph based on emotion information, the server reduces user interface update events and network messages, which reduces communication load. By tailoring generative AI outputs to be structurally constrained and context-aware, the server reduces the need for costly post-editing and repeated generation. These effects collectively improve performance characteristics of the computer system, including faster response times, lower error rates in generated content, and more efficient utilization of computational resources.

In a variation of the embodiment, the emotion recognition module may be replaced or supplemented by a model that uses only text-based user inputs, such as chat messages or free-form feedback, as features. The server then applies a language model fine-tuned for sentiment and emotion classification to derive emotion information solely from text. This variant may be used in environments where cameras or microphones are not available or are restricted. In another variation, the generative AI model may be deployed on-premises rather than as a remote service. In that case, the server includes a graphics processing unit or a specialized accelerator device configured to execute the transformer network. The server then controls memory management and batching strategies to maximize throughput and minimize inference latency, adjusting batch size and sequence length based on observed load.

In a further variation, the control information generation module may use a reinforcement learning agent that observes feedback information and processing results over time and learns a policy for constructing approval-flow control information that minimizes processing time and maximizes satisfaction indices. The agent operates on a state representation that includes evaluator tendencies, user preferences, emotion information, and current stage context, and outputs actions such as “merge two stages,” “hide optional fields,” or “increase explanation level.” The server uses the learned policy table or policy network to make decisions at runtime, further optimizing control over the approval procedure.

In all these embodiments, the key characteristic is that the server does not merely automate predefined approval steps or statically generate documents. Instead, the server implements specific data structures and algorithms that integrate business-related information, evaluator behavior, user behavior, and user emotion into approval-flow control information and prompt sentences for a generative AI model. This integration improves the way in which the computer system manages data, executes natural language processing, and controls workflows, and therefore constitutes an improvement to computer technology itself.

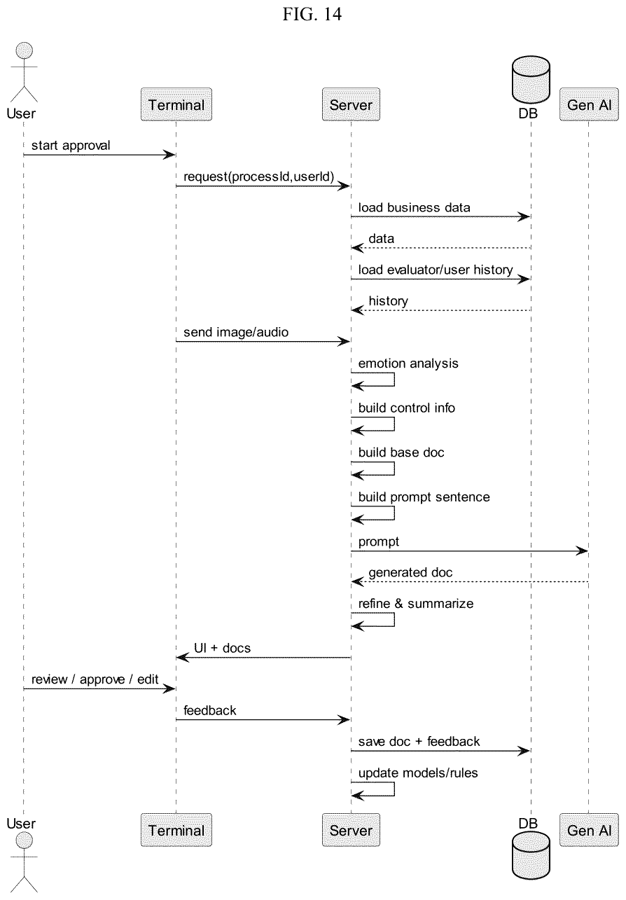

The following describes the processing flow using FIG. 14.

### Step 1:

Server initializes system configuration and resources.

Server receives as input configuration data specifying database connection parameters, model file locations, and API endpoints. Server loads this configuration into memory, establishes a connection to a database, and initializes software libraries for data processing, language processing, emotion recognition, and generative AI communication. Server loads pre-trained model parameters for an emotion recognition model, a preference analysis model, and, when hosted locally, a generative AI model into memory. As output, server produces an internal runtime state that includes active database sessions, loaded model objects, and a registry of available processing modules.

### Step 2:

Terminal acquires user interaction context and sensor data.

Terminal receives as input a user request to start or continue an approval process, such as selecting a project or document on the user interface. Terminal activates its camera and microphone, captures image frames of the user's face and audio segments of the user's voice, and encodes these signals into compressed digital formats. Terminal packages the user identifier, the current process identifier, and the captured sensor data into a message. As output, terminal sends this message over a network connection to the server.

### Step 3:

Server extracts business-related information for the current process.

Server receives as input a process identifier and optionally a stage identifier from the terminal request. Server issues one or more queries to the database to fetch business-related information such as project data, risk metrics, cost values, quality measurements, or transaction records relevant to the identified process and stage. Server converts the query results into in-memory data structures such as tables or arrays and performs data cleaning, aggregation, and normalization operations (for example, converting currencies, computing totals, and joining related tables). As output, server generates a structured business data set that contains the relevant fields and derived metrics for the current approval process.

### Step 4:

Server analyzes evaluator's evaluation history.

Server receives as input an evaluator identifier corresponding to the reviewer assigned to the current approval stage. Server queries the database for past evaluation history text, including prior comments and feedback associated with the evaluator identifier. Server uses a language processing method to tokenize and normalize the text, computes frequency statistics for terms and phrases, and extracts topic-related features using, for example, vectorization and dimensionality reduction. Server maps these features to a compact evaluation tendency representation, such as a vector whose dimensions represent emphasis on quantitative analysis, risk, schedule, usability, or other focus areas. As output, server records evaluation tendency information for the evaluator and makes it available to subsequent modules.

### Step 5:

Server analyzes user operation history and response history.

Server receives as input a user identifier and accesses stored logs of the user's past interactions with generated documents and interfaces. Server reads data such as which sections the user expanded, how long the user viewed each section, and what types of representations (tables, charts, or paragraphs) the user chose. Server encodes these observations into numerical feature vectors and applies a preference analysis model to estimate user preferences, including preferred level of detail, favored formats, and target summary length ranges. As output, server stores and returns user preference information associated with the user identifier.

### Step 6:

Server analyzes user state data to obtain emotion information.

Server receives as input image data and audio data from the terminal's camera and microphone. Server processes the image data to detect a face region and extract facial landmarks, and processes the audio data to compute features such as pitch and energy over time. Server concatenates visual and audio features and passes them through a trained emotion classification model implemented as a neural network. Based on the model output, server selects the most likely emotion label and corresponding confidence score, for example “stressed,” “neutral,” or “positive.” As output, server generates emotion information that includes the emotion label, intensity, and confidence, and stores it in association with the user and process identifiers.

### Step 7:

Server determines process-stage information and required information items.

Server receives as input a process identifier and current stage identifier from the terminal. Server queries the database for process-stage definitions, including lists of information items that must be reported at each stage and dependency relations among these items. Server organizes these items into an ordered list or graph structure and marks items as mandatory or optional. As output, server produces process-stage information containing the stage type, required information items, and any constraints, and forwards this to a control information generation module.

### Step 8:

Server generates approval-flow control information.

Server receives as input the process-stage information, evaluation tendency information, user preference information, and emotion information. Server applies rule-based logic or a compact decision model to determine which information items to display, in what order, and at what level of detail, taking into account evaluator focus, user preferences, and the user's emotional state. For example, when emotion information indicates a high-load state, server reduces the number of non-critical items and simplifies explanations. Server encodes the resulting configuration as approval-flow control information, which includes a representation of stages, included items, presentation order, and explanatory content parameters. As output, server stores and returns the approval-flow control information for use in document generation and terminal rendering.

### Step 9:

Server generates a document template and base document data.

Server receives as input the structured business data and the approval-flow control information. Server selects a document template pattern corresponding to the process type and stage, then maps each information item specified in the approval-flow control information to a placeholder in the template. Server fills the template with actual business data and derived metrics, formatting them as tables, bullet lists, or paragraphs according to template rules. As output, server produces base document data, which is a structured but not yet fully refined document ready for natural language enhancement and summarization.

### Step 10:

Server generates an intermediate summary and key data representation.

Server receives as input the base document data. Server applies language processing methods and rules to convert key numeric values and structured entries into short descriptive sentences, such as “Total cost increased by 8% compared to the previous period.” Server extracts and composes these sentences into an intermediate summary and selects a subset of the most important numeric and categorical fields to represent explicitly. As output, server generates an intermediate textual and metric representation that condenses the base document data into a compact form suitable for inclusion in a prompt sentence.

### Step 11:

Server composes a prompt sentence for the generative AI model.

Server receives as input the intermediate summary, evaluation tendency information, user preference information, emotion information, process-stage information, and base document data. Server uses generation rules of the prompt sentence to convert these inputs into a single coherent prompt sentence or multi-line prompt. Server incorporates explicit instructions about required sections, desired tone, target length, and structural constraints, such as “include an executive summary and then a detailed annex.” As output, server produces a prompt sentence that encodes all necessary context and constraints for a generative AI model to generate a customized document aligned with evaluator and user characteristics.

### Step 12:

Server invokes the generative AI model to generate document data.

Server receives as input the prompt sentence and, optionally, selected portions of the intermediate summary or base document data. Server sends this input to a generative AI model, for example a transformer-based language model, via an application programming interface or a local inference engine. Server specifies parameters such as maximum token length and decoding strategy. The generative AI model processes the input and returns newly generated text that conforms to the instruction in the prompt sentence. As output, server obtains generated document data that serves as an approval report document or an operational report document.

### Step 13:

Server analyzes and refines the generated document data.

Server receives as input the generated document data. Server applies language processing methods to segment the document into sections and sentences, verify that all required sections are present, and check consistency of key numeric values against the structured business data. When inconsistencies are detected, server corrects them by replacing erroneous values or by issuing a corrective prompt sentence to the generative AI model to regenerate specific parts. Server may also adjust headings or reformat lists to maintain uniform structure. As output, server produces refined generated document data that meets structural and factual constraints.

### Step 14:

Server generates summarized document data.

Server receives as input the refined generated document data and information indicating an understanding level or preference of the evaluator and user. Server applies summarization techniques, such as selecting the most informative sentences based on importance scores and compressing less critical parts, to generate a shorter version of the document. Server adjusts the length and complexity of the summary according to user preference information and, when available, understanding indices. As output, server generates summarized document data that provides a concise representation of the full document.

### Step 15:

Server prepares content for presentation on the terminal.

Server receives as input the approval-flow control information, refined generated document data, and summarized document data. Server structures this content into a hierarchical data format that specifies which sections and items to display in each stage, which elements should be expanded or collapsed, and what explanatory texts or hints should accompany each item. Server includes identifiers for interactive elements, such as approval buttons and comment fields. As output, server transmits this structured presentation data to the terminal.

### Step 16:

Terminal renders the approval interface and documents.

Terminal receives as input the presentation data from the server. Terminal interprets the structure, arranges sections on the display according to the specified presentation order, and renders both summarized and full document views, with controls to switch between them. Terminal displays any prompt-like hints or instructions that guide the user or evaluator, such as “Please pay special attention to the risk mitigation section.” As output, terminal presents an interactive user interface that allows the user or evaluator to read, approve, or correct the generated document.

### Step 17:

User reviews and interacts with the presented content.

User receives as input the visual representation of summarized document data and generated document data on the terminal display. User reads the content, compares sections, and, if necessary, scrolls through details and explanatory text. User performs approval operations by activating an approval control, performs correction operations by editing text fields or adjusting values, and submits feedback information by typing comments or selecting rating options. As output, user produces interaction events and textual feedback that terminal can capture.

### Step 18:

Terminal collects user operations and feedback.

Terminal receives as input the user's approval operations, corrections, and feedback inputs from the interface. Terminal aggregates these actions into a message that includes identifiers for the document, the stage, and the affected sections, as well as the full text of feedback or corrections. Terminal optionally records a final snapshot of user state, such as time taken on each section, which can be used to infer implicit understanding or difficulty. As output, terminal transmits this message to the server for further processing and storage.

### Step 19:

Server records feedback information and processing results.

Server receives as input the message from the terminal containing approval operations, correction operations, and feedback information. Server updates database records to store final document versions, decision outcomes, and timestamps. Server also logs metrics such as total processing time from initial request to approval, number of corrections required, and satisfaction indicators extracted from feedback text. As output, server maintains a persistent history of evaluations and interactions that can be used in future analyses and learning.

### Step 20:

Server updates evaluation tendency information, user preference information, emotion information, and prompt generation rules.

Server receives as input stored feedback information and recorded processing results for one or more completed approval sessions. Server analyzes how evaluator comments align with existing evaluation tendency information and updates evaluator vectors when shifts in focus are detected. Server analyzes user behavior and feedback to refine user preference information, for example by increasing weights on content formats that resulted in fewer corrections. Server evaluates emotion information against satisfaction outcomes to recalibrate thresholds for detecting high-load and low-load states. Server applies optimization techniques to adjust parameters and templates used by the prompt generation rules, favoring prompt patterns that led to faster approvals and higher satisfaction. As output, server generates updated evaluation tendency information, updated user preference information, updated emotion information, and refined generation rules of the prompt sentence, thereby improving the performance and accuracy of subsequent executions of the system.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

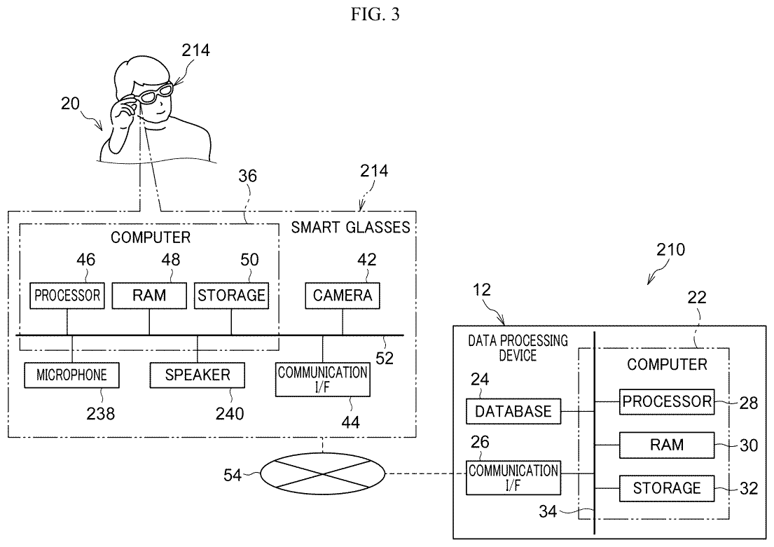

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

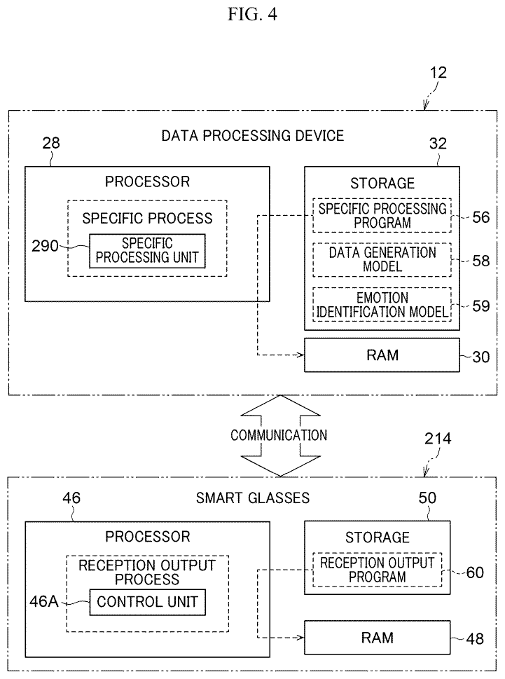

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

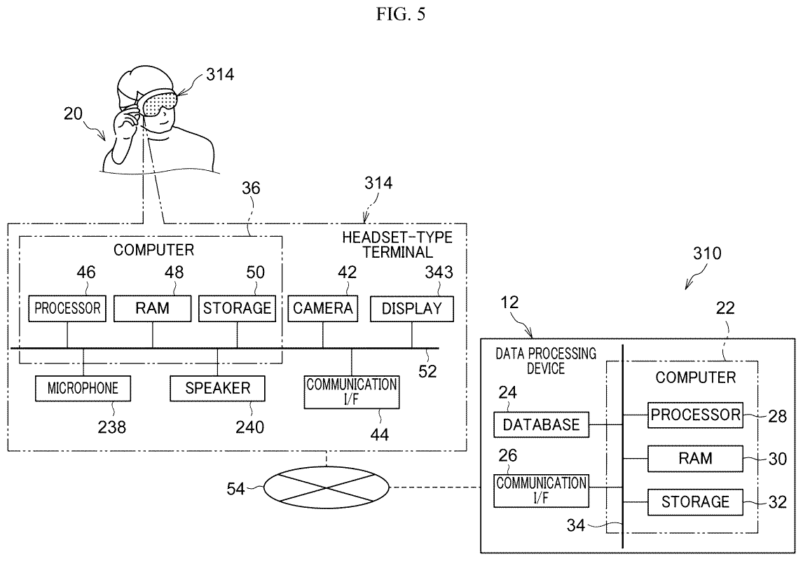

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

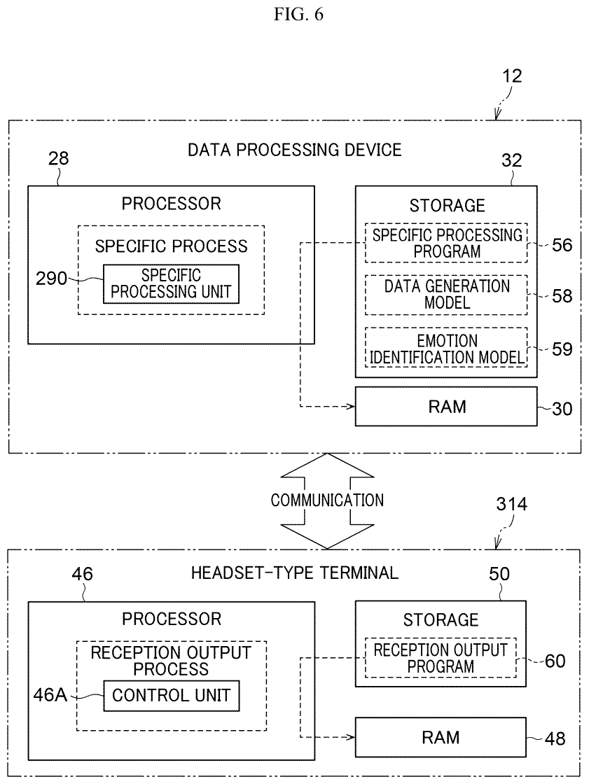

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

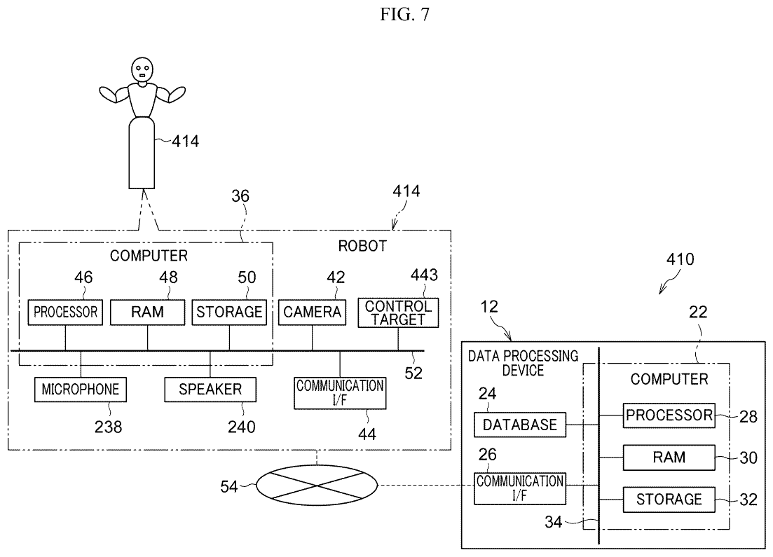

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

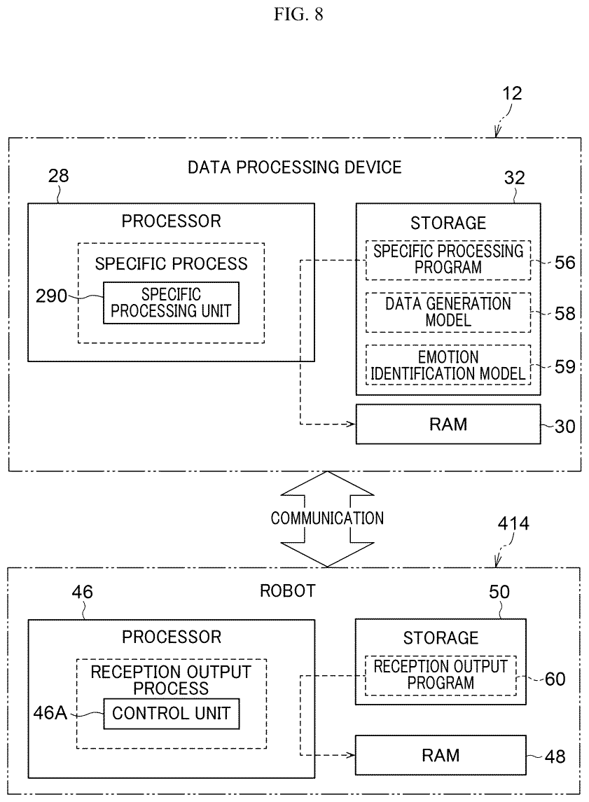

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

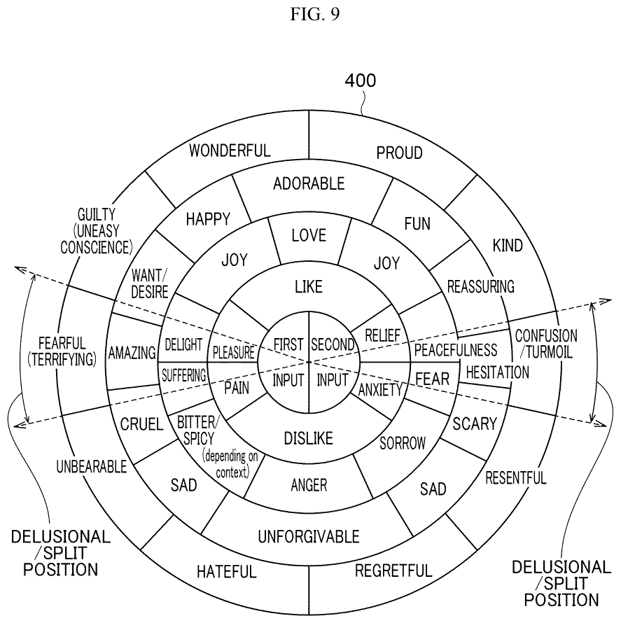

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

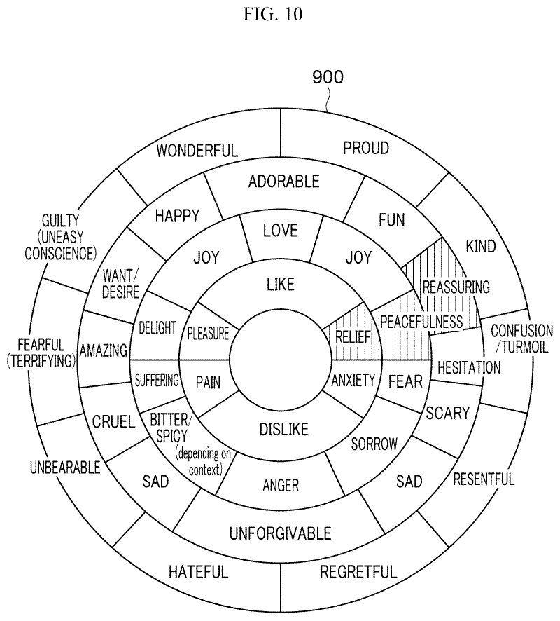

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive report item data input from a user terminal in each stage of an approval procedure, convert the report item data into structured data, and store the structured data in a storage device as an information set; and
extract, from the information set, historical data related to past approval procedures and comment history data of an evaluation entity, and calculate indicator values related to risk evaluation, budget planning, and personnel allocation, and comment tendency information for each evaluation entity by performing analysis processing including statistical processing and natural language processing, and record the indicator values and the comment tendency information; and
identify, based on the indicator values and the comment tendency information, report items required in a next stage of the approval procedure, and generate internal representation data that defines description contents to be included and viewpoints to be emphasized for each of the report items; and
generate a prompt sentence for instructing a generative AI model to generate a document by combining, in a predetermined language format, explanation information including the internal representation data and the indicator values; and
input the prompt sentence into the generative AI model, receive document data for the approval procedure output from the generative AI model, automatically generate a report document to be used in the next stage of the approval procedure based on the document data, and store the report document in the storage device; and
generate feedback information for a user, the feedback information indicating additional information to be provided and items to be corrected in the next stage of the approval procedure based on the automatically generated report document and a result of the analysis processing, and transmit the feedback information to the user terminal; and
accumulate, as the comment history data, approval results and comment information acquired from the evaluation entity, and update the comment tendency information, and dynamically adjust a generation process of the internal representation data so that interest items of the evaluation entity are reflected in the prompt sentence in subsequent executions.

### (Supplementary 2)

The system according to supplementary 1,
wherein the processor is configured to
execute summarization processing on the automatically generated report document, generate summarized document data in which main points related to the risk evaluation, the budget planning, and the personnel allocation are extracted and simplified so that the evaluation entity can grasp an overall situation in a short time, and output the summarized document data as presentation data.

### (Supplementary 3)

The system according to supplementary 1,
wherein the processor is configured to
present the summarized document data and the report document to a display device for the evaluation entity, acquire viewing operations and comment input history from the evaluation entity, and add the viewing operations and the comment input history to the information set as the comment history data, thereby improving accuracy of the comment tendency information that reflects a degree of understanding and fields of interest of the evaluation entity.

### Application Example 1

### (Supplementary 1)

A system comprising a processor and a storage device,
wherein the processor is configured to
associate each stage in an approval procedure with reporting information required in the stage, acquire the reporting information from the storage device based on stage information identifying the stage, and format the acquired reporting information as structured information, acquire evaluation history data of an evaluator from the storage device, analyze the evaluation history data by using a natural language processing technique, and convert a degree of interest and a priority item of the evaluator into numerical tendency information to be recorded in the storage device,
generate a prompt sentence for a generative information processing model based on the structured reporting information and the tendency information, input the prompt sentence and the structured reporting information into the generative information processing model to cause the generative information processing model to automatically generate an explanatory document, and store the explanatory document in the storage device, record progress status of the approval procedure as status information in the storage device, transmit the explanatory document and the status information to a user terminal via a communication network, receive response information including an approval instruction or a revision instruction from the user terminal, and update the status information based on the response information, and
when the revision instruction is received, regenerate the prompt sentence based on the revision instruction and additionally acquired reporting information, input the regenerated prompt sentence into the generative information processing model, and cause the generative information processing model to automatically generate a revised explanatory document.

### (Supplementary 2)

The system according to supplementary 1,
wherein the processor is configured to extract summary information from the explanatory document generated by the generative information processing model, generate a display document in which an item emphasized by the evaluator is highlighted based on the tendency information, and present the display document to the user terminal.

### (Supplementary 3)

The system according to supplementary 1,
wherein the processor is configured to acquire, from the storage device, the explanatory documents and the status information for a plurality of past cases in the approval procedure, generate a prompt sentence for the generative information processing model regarding the plurality of past cases, input the prompt sentence into the generative information processing model to cause the generative information processing model to generate integrated summary information including common points and differences among similar cases, and present the integrated summary information to the user terminal.

### Example 2

### (Supplementary 1)

A system comprising a processor,
wherein the processor is configured to
extract evaluation information related to business procedures from a data storage device and format the evaluation information into structured data including time information and identification information by using a predetermined information processing method, analyze comment histories of evaluators included in the structured data by using natural language processing technology and sentiment analysis technology to segment the comment histories into word units, and extract word occurrence frequencies, sentiment tendencies, and evaluation target items, and record, for each evaluator, an opinion tendency profile representing the evaluator's opinion tendencies,
extract, based on the opinion tendency profile, information items required for reporting in an approval procedure, automatically determine document structural elements for respective discussion points emphasized by the evaluator, and generate a prompt sentence for instructing a generative AI model to generate a document,
supply, to the generative AI model, input information including the prompt sentence, the opinion tendency profile, and the structured data, and acquire document text output from the generative AI model, the document text being adapted to the evaluator's opinion tendencies, automatically format the document text into a predetermined document format by using an application programming interface for document creation, and output the document text as an electronic document viewable by a user in the approval procedure, and
generate, based on the opinion tendency profile and the structured data, visualization data indicating attention words, evaluation target items, and sentiment tendencies for each evaluator, and output the visualization data as display image data.

### (Supplementary 2)

The system according to supplementary 1,
wherein the processor is configured to
extract, from the document text output from the generative AI model and from the opinion tendency profile, information items emphasized by the evaluator, generate a summary of the document text by using a summarization algorithm, and generate display data by combining a result of the summary with the visualization data, and determine a presentation format of the display data.

### (Supplementary 3)

The system according to supplementary 1,
wherein the processor is configured to
receive, from a user participating in the approval procedure, a prompt sentence representing a document generation request based on opinion tendencies of a specific evaluator, and dynamically generate input information for the generative AI model by appending the opinion tendency profile and the structured data to the prompt sentence, thereby automatically generating different document text for each evaluator according to respective stages of the approval procedure.

### Application Example 2

### (Supplementary 1)

A system comprising a processor and a storage device,
wherein the processor is configured to
extract business-related information from the storage device and integrate and structure the business-related information by using an information processing method,
analyze an evaluation history of an evaluator by using a language processing method and
generate and record evaluation tendency information indicating elements emphasized by the evaluator,
analyze an operation history and a response history of a user and generate and record user preference information indicating an information format and a level of detail preferred by the user,
analyze user state data acquired from an image acquisition apparatus and an audio acquisition apparatus by using an emotion recognition method and generate and record emotion information indicating an emotional state of the user,
refer to process-stage information in an approval process, the evaluation tendency information, the user preference information, and the emotion information, and generate approval-flow control information that defines information items to be reported in the approval process and a presentation order, a level of detail, and explanatory content of the information items,
generate a document template based on the approval-flow control information and the integrated and structured business-related information, and generate base document data by embedding the business-related information into the document template,
generate a prompt sentence as an instruction text for input to a generative model based on the base document data, the evaluation tendency information, the user preference information, and the emotion information, and transmit the prompt sentence to a generative AI model included in the generative model to automatically generate generated document data serving as an approval report document or an operational report document,
analyze the generated document data by using the language processing method, extract important information, and generate summarized document data according to an understanding level of the evaluator or the user,
present the summarized document data and the generated document data on a display apparatus based on the approval-flow control information, acquire an approval operation, a correction operation, and feedback information from the evaluator or the user, and record the feedback information in the storage device, and
update, in a learning manner, the evaluation tendency information, the user preference information, the emotion information, and generation rules of the prompt sentence based on the feedback information and a processing result.

### (Supplementary 2)

The system according to supplementary 1,
wherein the processor is configured to, when updating the generation rules of the prompt sentence, evaluate a processing time of the approval process, an understanding-level index of the evaluator, and a satisfaction index of the user, and dynamically adjust a length, a structure, and an expression style of the prompt sentence input to the generative AI model based on evaluation results, thereby improving quality of the generated document data and the summarized document data.

### (Supplementary 3)

The system according to supplementary 1,
wherein the processor is configured to, when generating the approval-flow control information, change a number of stages of the approval process, a number of information items presented in each stage, and an amount of explanation based on the emotion information, simplify the stages of the approval process when the user is in a high-load state, and present detailed explanations and additional information when the user is in a low-load state, thereby dynamically controlling an approval procedure.

What is claimed is:

1. A system comprising:
circuitry configured to:
extract, from a data storage device coupled to a packet-switched network, structured records associated with a multi-stage sequential procedure, the structured records comprising time-series interaction data and entity-associated textual annotation data;
apply a natural language processing pipeline to the entity-associated textual annotation data to compute, for each entity identifier, a numerical tendency vector encoding attention-word frequencies and sentiment scores across a plurality of evaluation dimensions;
construct a prompt sequence for a generative neural network model by combining, in a predetermined template format, the numerical tendency vector and indicator values derived from statistical processing of the structured records;
transmit the prompt sequence to the generative neural network model via a communication interface coupled to the packet-switched network, receive generated document data from the generative neural network model, and store the generated document data in the data storage device; and
apply a summarization algorithm to the generated document data to produce condensed output data, and transmit the condensed output data to a terminal device via the communication interface.

2. The system according to claim 1, wherein the natural language processing pipeline comprises tokenization, stop-word removal, and lemmatization operations applied to the entity-associated textual annotation data to produce normalized token sequences.

3. The system according to claim 2, wherein the circuitry is configured to compute term frequency-inverse document frequency vectors from the normalized token sequences and to apply a clustering algorithm to group the term frequency-inverse document frequency vectors into evaluation dimension categories.

4. The system according to claim 3, wherein the circuitry is configured to apply a trained neural network classifier to the term frequency-inverse document frequency vectors to compute per-dimension sentiment scores, the trained neural network classifier comprising a feedforward architecture with rectified linear unit activation functions trained using a cross-entropy loss function.

5. The system according to claim 4, wherein the evaluation dimensions comprise risk assessment focus, cost analysis focus, schedule compliance focus, and quality assurance focus, and wherein the numerical tendency vector associates each entity identifier with a weight value for each evaluation dimension.

6. The system according to claim 1, wherein the indicator values comprise descriptive statistical metrics computed from the structured records, the descriptive statistical metrics comprising mean values, variance values, and correlation coefficients for numerical attributes filtered by procedure stage and record category.

7. The system according to claim 6, wherein the circuitry is configured to generate internal representation data that defines, for each required data item in a subsequent stage of the multi-stage sequential procedure, description contents and emphasized viewpoints determined based on the numerical tendency vector.

8. The system according to claim 7, wherein the prompt sequence comprises an instruction segment describing a generation task, a context segment encoding the internal representation data and the indicator values in a human-readable textual table format, and a preference segment derived from the numerical tendency vector specifying which evaluation dimensions to emphasize.

9. The system according to claim 8, wherein the generative neural network model comprises a transformer architecture with multiple self-attention layers and feed-forward sublayers, and wherein the circuitry specifies generation parameters comprising maximum output length, sampling temperature, and repetition penalty.

10. The system according to claim 1, wherein the circuitry is configured to validate the generated document data by parsing the generated document data to extract numerical expressions and cross-checking the numerical expressions against the indicator values stored in the data storage device.

11. The system according to claim 10, wherein the circuitry is configured to, upon detecting a discrepancy between a numerical expression in the generated document data and a corresponding indicator value exceeding a predetermined tolerance threshold, generate a corrective prompt sequence and retransmit the corrective prompt sequence to the generative neural network model to regenerate a corrected portion of the generated document data.

12. The system according to claim 11, wherein the summarization algorithm comprises computing importance scores for individual sentences in the generated document data and selecting a subset of sentences whose cumulative importance score exceeds a relevance threshold.

13. The system according to claim 12, wherein the circuitry is configured to generate feedback data indicating additional information to be provided and items to be corrected based on the generated document data and the indicator values, and transmit the feedback data to the terminal device.

14. The system according to claim 1, wherein the circuitry is configured to receive response data from the terminal device comprising a revision instruction associated with a specific section identifier, construct a section-targeted prompt sequence incorporating the revision instruction and additionally acquired structured records, and transmit the section-targeted prompt sequence to the generative neural network model to regenerate only the specific section of the generated document data.

15. The system according to claim 1, wherein the circuitry is configured to accumulate, as updated textual annotation data, interaction data and annotation inputs received from the terminal device, re-execute the natural language processing pipeline on the updated textual annotation data, and update the numerical tendency vector stored in the data storage device.

16. The system according to claim 1, wherein the circuitry is configured to acquire viewing operation data from the terminal device indicating section-level dwell times and expansion events, and to adjust the numerical tendency vector based on a correlation between the viewing operation data and the evaluation dimensions.

17. The system according to claim 1, wherein the multi-stage sequential procedure is an approval workflow procedure, the entity-associated textual annotation data comprises evaluator comment histories, and the generated document data comprises an approval report document.

18. A system comprising:
circuitry configured to:
extract, from a data storage device coupled to a packet-switched network, structured records comprising time-series interaction data and entity-associated textual annotation data, the structured records organized in relational tables indexed by entity identifiers and stage identifiers;
apply a natural language processing pipeline comprising tokenization, lemmatization, and term frequency-inverse document frequency vectorization to the entity-associated textual annotation data, and apply a trained classifier to the vectorized data to compute, for each entity identifier, a numerical tendency vector encoding per-dimension sentiment scores and attention-word frequencies;
generate internal representation data defining description contents and emphasized viewpoints for each required data item based on the numerical tendency vector and indicator values derived from statistical processing of the structured records;
construct a prompt sequence by serializing the internal representation data and the indicator values into a template comprising an instruction segment, a data segment, and a preference segment derived from the numerical tendency vector, and transmit the prompt sequence to a transformer-based generative neural network model via a communication interface coupled to the packet-switched network;
receive generated document data from the transformer-based generative neural network model, validate the generated document data by cross-checking extracted numerical expressions against the indicator values, apply a summarization algorithm to produce condensed output data, and transmit the condensed output data to a terminal device via the communication interface; and
accumulate updated textual annotation data received from the terminal device, re-execute the natural language processing pipeline to update the numerical tendency vector, and dynamically adjust the internal representation data generation based on the updated numerical tendency vector.

19. The system according to claim 18, wherein the circuitry is configured to analyze user state data acquired from an image acquisition apparatus and an audio acquisition apparatus using an emotion recognition neural network to generate emotion information, and to modify the internal representation data and the prompt sequence based on the emotion information to adjust a level of detail and a presentation order of information items in the generated document data.

20. A method performed by a system comprising circuitry, the method comprising:
extracting, from a data storage device coupled to a packet-switched network, structured records associated with a multi-stage sequential procedure, the structured records comprising time-series interaction data and entity-associated textual annotation data;
applying a natural language processing pipeline to the entity-associated textual annotation data to compute, for each entity identifier, a numerical tendency vector encoding attention-word frequencies and sentiment scores across a plurality of evaluation dimensions;
constructing a prompt sequence for a generative neural network model by combining, in a predetermined template format, the numerical tendency vector and indicator values derived from statistical processing of the structured records;
transmitting the prompt sequence to the generative neural network model via a communication interface coupled to the packet-switched network, receiving generated document data from the generative neural network model, and storing the generated document data in the data storage device; and
applying a summarization algorithm to the generated document data to produce condensed output data, and transmitting the condensed output data to a terminal device via the communication interface.
